(19) United States
(12) Patent Application Publication
(10) Pub. No.: US 2023/0078710 A1
(43) Pub. Date: Mar. 16, 2023

(54) SECONDARY BATTERY, BATTERY PACK, VEHICLE, AND STATIONARY POWER SUPPLY

(71) Applicant: KABUSHIKI KAISHA TOSHIBA, Tokyo (JP)

(72) Inventors: Keigo HOSHINA, Yokohama (JP); Yumiko SEKIGUCHI, Kawasaki (JP); Yasuyuki HOTTA, Tokyo (JP); Shinsuke MATSUNO, Tokyo (JP); Norio TAKAMI, Yokohama (JP)

(73) Assignee: KABUSHIKI KAISHA TOSHIBA, Tokyo (JP)

(21) Appl. No.: 17/650,774

(22) Filed: Feb. 11, 2022

(30) Foreign Application Priority Data
Sep. 15, 2021 (JP) 2021-150358

(51) Int. Cl. H01M 50/54; H01M 50/543; H01M 4/66; H01M 50/534; H01M 4/485

(52) U.S. Cl. CPC H01M 50/54; H01M 50/543; H01M 4/662; H01M 50/534; H01M 4/667; H01M 4/485; H01M 2220/20

(57) ABSTRACT

According to one embodiment, a secondary battery is provided. The secondary battery includes a first electrode having a first current collector, second electrode having a second current collector, and an aqueous electrolyte. The first electrode includes a first lead, and a first joint for electrically connecting the first current collector and the first lead. At least a part of the surface of the first current collector has a first current collector coating. At least a part of the surface of the first lead has a first lead coating. The thickness of the first lead coating is larger than the thickness of the first current collector coating.

### CROSS-REFERENCE TO RELATED APPLICATIONS

This application is based upon and claims the benefit of priority from Japanese Patent Application No. 2021-150358, filed Sep. 15, 2021, the entire contents of which are incorporated herein by reference.

### FIELD

Embodiments described herein relate generally to a secondary battery, a battery pack, a vehicle, and a stationary power supply.

### BACKGROUND

In recent years, as a high energy density type secondary battery, a battery using a nonaqueous solvent, such as a lithium ion secondary battery, has been developed. Lithium-ion secondary batteries are superior to lead storage batteries and nickel-hydrogen secondary batteries in terms of energy density and cycle characteristics, and are expected as power sources for large-scale storage, such as power sources for vehicles such as hybrid vehicles and electric vehicles.

As an electrolytic solution of a lithium ion secondary battery, a nonaqueous solvent such as ethylene carbonate, diethyl carbonate, or propylene carbonate is used from the viewpoint of having a wide potential window. Since these solvents are combustible, there is a problem in safety. Therefore, if the nonaqueous electrolyte solution can be replaced with an aqueous electrolyte solution, this problem can be fundamentally solved. In addition, the aqueous electrolyte solution is cheaper than the nonaqueous electrolyte solution, and it is not necessary to perform the manufacturing process in an inert atmosphere. Therefore, it can be expected that the cost is significantly reduced by replacing the nonaqueous electrolyte solution with an aqueous electrolyte solution.

However, there is a major problem in using an aqueous electrolyte solution in a lithium ion secondary battery. This is because a theoretical decomposition voltage calculated based on the chemical equilibrium of water is 1.23 V, so when a battery is configured with a design voltage exceeding the theoretical decomposition voltage, oxygen will be generated at its positive electrode and hydrogen will be generated at its negative electrode.

### BRIEF DESCRIPTION OF THE DRAWINGS

FIG. 1 is a cross-sectional view schematically showing an example of a secondary battery according to an embodiment;

FIG. 2 is an enlarged cross-sectional view showing a part A shown in FIG. 1;

FIG. 3 is a cross-sectional view taken along line of the secondary battery shown in FIG. 1;

FIG. 4 is an enlarged schematic cross-sectional view showing the vicinity of a joint between a negative electrode current collector and a negative electrode lead;

FIG. 5 is a cross-sectional view schematically showing another example of the cross section of the secondary battery according to the embodiment;

FIG. 6 is a cross-sectional view schematically showing an example of the secondary battery according to the embodiment;

FIG. 7 is an enlarged cross-sectional view showing a part A shown in FIG. 6;

FIG. 8 is a perspective view schematically showing an example of an battery module according to the embodiment;

FIG. 9 is an exploded perspective view schematically showing an example of a battery pack according to the embodiment;

FIG. 10 is a block diagram showing an example of an electric circuit of the battery pack shown in FIG. 9;

FIG. 11 is a cross-sectional view schematically showing an example of a vehicle according to an embodiment; and

FIG. 12 is a block diagram showing an example of a system including a stationary power supply according to an embodiment.

### DETAILED DESCRIPTION

According to one embodiment, a secondary battery is provided. The secondary battery includes a first electrode having a first current collector, a second electrode having a second current collector, and an aqueous electrolyte. The first electrode includes a first lead, and a first joint for electrically connecting the first current collector and the first lead. The second electrode includes a second lead, and a second joint for electrically connecting the second current collector and the second lead. The first electrode is one of a positive electrode and a negative electrode, and the second electrode is the other of the positive electrode and the negative electrode. At least a part of the surface of the first current collector has a first current collector coating. At least a part of the surface of the first lead has a first lead coating. Each of the first current collector and the first lead contains at least one selected from the group consisting of aluminum, aluminum alloys, copper, and nickel. Each of the first lead coating and the first current collector coating contains at least one selected from the group consisting of aluminum oxide, aluminum oxyhydroxide, chromium-containing compounds, and zinc-containing compounds. At least a part of the surface of the second current collector has a second current collector coating. At least a part of the surface of the second lead has a second lead coating. Each of the second current collector and the second lead contains at least one selected from the group consisting of aluminum, aluminum alloys, copper, and nickel. Each of the second lead coating and the second current collector coating contains at least one selected from the group consisting of aluminum oxide, aluminum oxyhydroxide, chromium-containing compounds, and zinc-containing compounds. The thickness of the first lead coating is larger than the thickness of the first current collector coating.

According to another embodiment, a battery pack is provided. The battery pack includes the secondary battery according to the embodiment.

According to another embodiment, a vehicle is provided. The vehicle includes the battery pack according to the embodiment.

According to another embodiment, a stationary power supply is provided. The stationary power supply includes the battery pack according to the embodiment.

Hereinafter, embodiments will be described with reference to the drawings. It should be noted that the same reference numerals are given to common configurations throughout the embodiments, and duplicate description will be omitted. In addition, each drawing is a schematic diagram for explaining the embodiments and promoting its understanding, and the shape, dimensions, ratio, and the like are different from those of the actual device, but these can be changed in design as appropriate by taking into consideration the following description and known techniques.

Conventionally, in a secondary battery provided with a nonaqueous electrolyte solution, aluminum or an aluminum alloy is mainly used as a positive electrode current collector, and copper is used as a negative electrode current collector. However, it is difficult to use a positive electrode current collector and a negative electrode current collector made of these materials as they are in an aqueous secondary battery. The reason is that aluminum is easily corroded in an aqueous electrolyte solution, and when it is used as a positive electrode current collector, excessive oxygen may be generated.

An attempt has been made to use titanium metal with a high oxygen overvoltage as the positive electrode current collector for the purpose of suppressing the electrolysis of water in the positive electrode. However, when titanium is used, there is a problem that the cost is high and the battery resistance increases as compared with the case where aluminum is used.

Further, an attempt has been made to use zinc or tin as a negative electrode current collector for the purpose of suppressing the electrolysis of water in the negative electrode. Since zinc and tin have a high hydrogen overvoltage, hydrogen generation in the aqueous electrolyte solution can be suppressed as compared with the case where copper or aluminum is used. However, the strength of zinc and tin tends to decrease in a temperature range of 150° C. or higher. Therefore, when active material-containing slurry is applied and dried on a current collector foil made of these metals, there is a concern that a defect such as tearing of the current collector foil may occur. In addition, tin has the property of becoming brittle in a low temperature environment of −10° C. or lower, so it may be restricted by an environment in which a secondary battery is used.

### First Embodiment

According to the first embodiment, a secondary battery is provided. The secondary battery includes a first electrode having a first current collector, a first lead, a first joint for electrically connecting the first current collector and the first lead, a second electrode having a second current collector, a second lead, a second joint for electrically connecting the second current collector and the second lead, and an aqueous electrolyte. The first electrode is one of a positive electrode and a negative electrode, and the second electrode is the other of the positive electrode and the negative electrode. At least a part of the surface of the first current collector has a first current collector coating. At least a part of the surface of the first lead has a first lead coating. Each of the first current collector and the first lead contains at least one selected from the group consisting of aluminum, aluminum alloys, copper, and nickel. Each of the first lead coating and the first current collector coating contains at least one selected from the group consisting of aluminum oxide, aluminum oxyhydroxide, chromium-containing compounds, and zinc-containing compounds. At least a part of the surface of the second current collector has a second current collector coating. At least a part of the surface of the second lead has a second lead coating. Each of the second current collector and the second lead contains at least one selected from the group consisting of aluminum, aluminum alloys, copper, and nickel. Each of the second lead coating and the second current collector coating contains at least one selected from the group consisting of aluminum oxide, aluminum oxyhydroxide, chromium-containing compounds, and zinc-containing compounds. The thickness of the first lead coating is larger than the thickness of the first current collector coating.

In the secondary battery according to the embodiment, the electrode current collectors included in both the positive and negative electrodes and the lead members electrically connected to the electrode current collectors are all provided with a specific type of protective coating. Moreover, on at least one of the positive electrode side and the negative electrode side, the thickness of the protective coating provided on the surface of the lead member is larger than the thickness of the protective coating provided on the surface of the current collector.

On the positive electrode side, when the thickness of the protective coating provided on the surface of the lead member is larger than the thickness of the protective coating provided on the surface of the current collector, it is easy to suppress the oxidative decomposition of water on the surface of the lead member. Therefore, it is possible to suppress the generation of oxygen on the positive electrode side. Further, on the negative electrode side, when the thickness of the protective coating provided on the surface of the lead member is larger than the thickness of the protective coating provided on the surface of the current collector, it is easy to suppress reductive decomposition of water on the surface of the lead member. Therefore, it is possible to suppress the generation of hydrogen on the negative electrode side. In both the positive and negative electrodes, when the thicknesses of the protective coatings provided on the surfaces of the lead members are larger than the thicknesses of the protective coatings provided on the surfaces of the current collectors, it is possible to remarkably suppress the electrolysis of water.

When the lead member and the current collector are joined to each other, the lead member is more susceptible to damage due to energy for the joining as compared with the current collector. However, on at least one of the positive electrode side and the negative electrode side, the thickness of the protective coating provided on the surface of the lead member is larger than the thickness of the protective coating provided on the surface of the current collector, and thus it is possible to suppress the exposure of a base material at the time of the joining. Therefore, direct contact of the aqueous electrolyte with the lead member or the base material of the current collector is suppressed, and the effect of easily suppressing the electrolysis of water in the vicinity of the joint can be obtained. Therefore, the secondary battery according to the embodiment can achieve excellent charge/discharge efficiency even after repeating a charge/discharge cycle a plurality of times.

Since both the positive electrode current collector and the negative electrode current collector contain aluminum, an aluminum alloy, copper, or nickel in the secondary battery according to the embodiment, the secondary battery does not have the above-mentioned problem, that is, the problem that titanium, zinc, or tin is used as the current collectors.

Examples of members having a large contact area with an aqueous electrolyte solution inside a container member are the positive electrode current collector, the negative electrode current collector, the positive electrode side lead electrically connected to the positive electrode current collector, and the negative electrode side lead electrically connected to the negative electrode current collector. In the secondary battery according to the embodiment, all of the positive electrode current collector, the negative electrode current collector, the positive electrode side lead, and the negative electrode side lead have, on at least a part of the surfaces of these members, a protective coating containing at least one selected from the group consisting of aluminum oxide aluminum oxyhydroxide, chromium-containing compounds, and zinc-containing compounds. Therefore, metal as the base materials of these members is not exposed, or the areas of exposed portions of these members are small. As a result, the electrolysis of water can be suppressed. Therefore, according to this secondary battery, excellent charge/discharge efficiency can be achieved.

Hereinafter, the secondary battery according to the embodiment will be described in detail.

The secondary battery according to the embodiment may include a separator interposed between the positive electrode and the negative electrode. The positive electrode, the negative electrode, and the separator can form an electrode group. The electrode group may be a stacked electrode group or a wound electrode group. The secondary battery may further include a container member capable of accommodating the electrode group and the aqueous electrolyte. Further, the secondary battery may further include a positive electrode terminal electrically connected to a positive electrode side lead member (positive electrode lead) and a negative electrode terminal electrically connected to a negative electrode side lead member (negative electrode lead).

In the present specification and claims, the “first electrode” includes the “first current collector”, the “first lead”, the “first joint”, the “first current collector coating”, and the “first lead coating”. Therefore, for example, when the “first electrode” is the negative electrode, the “first current collector”, the “first lead”, the “first joint”, the “first current collector coating”, and the “first lead coating” may be a “negative electrode current collector”, a “negative electrode lead”, a “negative electrode joint”, a “negative electrode current collector coating”, and a “negative electrode lead coating”, respectively.

Similarly, in the present specification and claims, the “second electrode” includes the “second current collector”, the “second lead”, the “second joint”, the “second current collector coating”, and the “second lead coating”. Therefore, for example, when the “second electrode” is the positive electrode, the “second current collector”, the “second lead”, the “second joint”, the “second current collector coating”, and the “second lead coating” may be a “positive electrode current collector”, a “positive electrode lead”, a “positive electrode joint”, a “positive electrode current collector coating”, and a “positive electrode lead coating”, respectively.

The first electrode is one of a positive electrode and a negative electrode, and the second electrode is the other of the positive electrode and the negative electrode. Whether the positive electrode or the negative electrode is the first electrode is determined based on the magnitude relationship between the lead coating and the current collector coating for the electrode. For example, when the negative electrode lead coating is thick as the negative electrode current collector coating and the thickness of the positive electrode lead coating is equal to or smaller than that of the positive electrode current collector coating, the negative electrode defined as the first electrode. On the other hand, when the positive electrode lead coating is thick as the positive electrode current collector coating and the thickness of the negative electrode lead coating is equal to or smaller than that of the negative electrode current collector coating, the positive electrode defined as the first electrode. When the negative electrode lead coating is thicker than the negative electrode current collector coating and the positive electrode lead coating is thicker than the positive electrode current collector coating, the negative electrode defined as the first electrode and the positive electrode defined as the second electrode.

The negative electrode, the negative electrode lead, the negative electrode terminal, the positive electrode, the positive electrode lead, the positive electrode terminal, the aqueous electrolyte, the separator, and the container member will be described below.

(1) Negative Electrode

The negative electrode may include a negative electrode current collector and a negative electrode active material-containing layer supported on one or both surfaces of the negative electrode current collector. The negative electrode active material-containing layer contains a negative electrode active material.

As the material of the negative electrode current collector, a substance that is electrochemically stable in the negative electrode potential range when an alkali metal ion is inserted or extracted is used. The negative electrode current collector is, for example, a foil containing aluminum, an aluminum alloy, copper, or nickel. The negative electrode current collector may be a foil made of aluminum, an aluminum alloy, copper, or nickel. The aluminum alloy foil may contain at least one element selected from magnesium (Mg), titanium (Ti), zinc (Zn), manganese (Mn), iron (Fe), copper (Cu), and silicon (Si). The negative electrode current collector may be in another form such as a porous body or a mesh. The properties of the material (base material) constituting the negative electrode current collector may be the same as or different from the properties of the material (base material) constituting the positive electrode current collector described later.

When aluminum or an aluminum alloy is used as the negative electrode current collector, the energy density can be increased because aluminum is the lightest metal among metals. Aluminum or an aluminum alloy is also preferable in terms of low cost. When copper or nickel is used as the negative electrode current collector, the conductivity of these metals is high, and thus a battery with low resistance can be obtained. It also has the advantage of being easily processed.

Further, the negative electrode current collector may include a portion on which the negative electrode active material-containing layer is not formed on the surface thereof. This portion can serve as a negative electrode current-collecting tab.

The thickness of the negative electrode current collector is in the range of 10 μm to 70 μm according to one example, and is in the range of 20 μm to 50 μm according to another example. When the thickness of the negative electrode current collector is in the range of 20 μm to 50 μm, the negative electrode current collector is excellent in processability in a process of coating electrode slurry and an electrode pressing process, and the energy density can be increased. If the current collector is too thin, there is a concern that the current collector may be cut or wrinkled in the electrode production process. If the current collector is made too thick, the processability is improved, but the energy density tends to decrease.

At least a part of the surface of the negative electrode current collector has a negative electrode current collector coating. It is preferable that the entire surface of the negative electrode current collector have a negative electrode current collector coating.

The negative electrode current collector coating contains at least one selected from the group consisting of aluminum oxide, aluminum oxyhydroxide, chromium-containing compounds, and zinc-containing compounds. The negative electrode current collector coating may be a coating in which two or more layers containing one of these compounds are stacked. For example, the negative electrode current collector coating may have a stacked structure of a coating containing aluminum oxide and a coating containing a chromium-containing compound. When two or more coatings are present, the coatings are collectively referred to as negative electrode current collector coating. When two or more coatings of different types are formed, the advantages of each coating can be obtained at the same time. In addition, the ease of adjusting the thickness of each coating varies depending on the type of the coating to be formed. Therefore, it is preferable that two or more types of coatings be stacked to form the negative electrode current collector coating, because the thickness of the entire negative electrode current collector coating can be easily adjusted.

The thickness of the negative electrode current collector coating is, for example, in the range of 1 μm or more and 10 μm or less, preferably in the range of 2 μm or more and 5 μm or less. When the thickness of the negative electrode current collector coating is in the range of 2 μm or more and 5 μm or less, the effect of suppressing side reactions is likely to be obtained by the coating, the coating is not too thick, and thus the electrical resistance is unlikely to increase significantly due to the coating. When two or more coatings are present, the total thickness of the coatings is the thickness of the negative electrode current collector coating.

Examples of the aluminum oxide include α-alumina (Al₂O₃), β-alumina (Na₂O.6Al₂O₃), and γ-alumina (Al₂O₃.nH₂O). The coating containing the aluminum oxide can be produced, for example, by an anodizing method described later.

The aluminum oxyhydroxide is also referred to as aluminum hydroxide or boehmite. The chemical formula is AlO(OH). The coating containing the aluminum oxyhydroxide can be produced, for example, by boehmite treatment described later.

Examples of the chromium-containing compounds include compounds contained in a coating formed by chromate treatment described later. Examples of chromium-containing compounds include Cr(OH)₃ and Cr₂O₃.nH₂O.

Examples of the zinc-containing compounds include compounds contained in a coating formed by zincate treatment described later. Examples of the zinc-containing compounds include Zn, Zn(OH)₂, and ZnO.

The negative electrode active material-containing layer is provided on the negative electrode current collector, for example, with a basis weight in the range of 20 g/m² or more and 500 g/m² or less. When the basis weight is in this range, reversible charging can be performed. An active material layer with a basis weight of less than 20 g/m² is not preferable because it is difficult to manufacture it by coating. Further, in the active material layer having a basis weight of more than 500 g/m², the Li concentration gradient in the layer becomes large at the time of Li insertion/extraction during charging/discharging, so that the battery characteristics may deteriorate.

The porosity of the negative electrode active material-containing layer is preferably set to 20% to 50%. This makes it possible to obtain a negative electrode having good affinity for the aqueous electrolyte and having a high density. The porosity of the negative electrode active material-containing layer is more preferably 25% to 40%.

The porosity of the negative electrode active material-containing layer can be obtained by, for example, mercury porosimetry. More specifically, first, the pore distribution of the active material-containing layer is obtained by mercury porosimetry. Next, the total pore amount is calculated from the pore distribution. Next, the porosity can be calculated from the ratio of the total pore amount and the volume of the active material-containing layer.

The negative electrode active material includes, for example, at least one selected from the group consisting of carbon materials, silicon, silicon oxide, and titanium-containing oxide. Examples of the carbon materials include artificial graphite, natural graphite, and spindle-shaped graphite obtained by compacting natural graphite and coating it with carbon.

The negative electrode active material may be a compound having a lithium ion insertion/extraction potential based on metallic lithium and having a potential of 1 V (vs.Li/Li⁺) or more and 3 V or less (vs.Li/Li⁺).

As the titanium-containing oxide, at least one selected from the group consisting of titanium oxide, lithium titanium composite oxide, niobium titanium composite oxide, and sodium niobium titanium composite oxide can be used. The negative electrode active material may contain one or more types of titanium-containing oxide.

The titanium oxide includes, for example, a titanium oxide having a monoclinic structure, a titanium oxide having a rutile structure, and a titanium oxide having an anatase structure. For titanium oxides of these crystal structures, the composition before charge can be expressed as TiO₂, and the composition after charge can be expressed as LiₓTiO₂ (0≤x≤1). In addition, the structure of titanium oxide having a monoclinic structure before charge can be expressed as TiO₂(B).

The lithium titanium composite oxide includes, for example, a lithium titanium composite oxide having a spinel structure (for example, the general formula is Li₄₊ₓTi₅O₁₂ (−1≤x≤3)), a lithium titanium composite oxide having a ramsdellite structure (for example, Li₂₊ₓTi₃O₇ (−1≤x≤3)), Li₁₊ₓTi₂O₄ (0≤x≤1), Li_{1.1+x}Ti_{1.8}O₄ (0≤x≤1), Li_{1.07+x}Ti_{1.86}O₄ (0≤x≤1), and LiₓTiO₂ (0≤x≤1), and the like. The lithium titanium composite oxide may be a lithium titanium composite oxide in which a dopant is introduced.

The niobium titanium composite oxides include, for example, a material expressed as LiₐTiM_{b}Nb_{2±β}O_{7+σ} (0≤a≤5, 0≤b≤0.3, 0≤β≤0.3, 0≤σ≤0.3, M is at least one element selected from the group consisting of Fe, V, Mo, and Ta).

The sodium titanium oxides include, for example, an orthorhombic Na-containing niobium titanium composite oxide represented by the general formula Li₂₊ᵥNa_{2-w}M1ₓTi_{6-y-z}Nb_{y}M2_{z}O_{14+δ} (0≤v≤4, 0≤w<2, 0≤x<2, 0≤y<6, 0≤z<3, −0.5≤δ≤0.5, M1 includes at least one element selected from the group consisting of Cs, K, Sr, Ba, and Ca, and M2 includes at least one element selected from the group consisting of Zr, Sn, V, Ta, Mo, W, Fe, Co, Mn, and Al).

The negative electrode active material is contained in the negative electrode active material-containing layer in a form of, for example, particles. The negative electrode active material particles can be primary particles, secondary particles as the aggregates of primary particles, or a mixture of single primary particles and secondary particles. The shape of a particle is not particularly limited and can be, for example, spherical, elliptical, flat, or fibrous.

An average particle size (diameter) of primary particles of the negative electrode active material is preferably 3 μm or less and more preferably 0.01 μm or more and 1 μm or less. An average particle size (diameter) of secondary particles of the negative electrode active material is preferably 30 μm or less and more preferably 5 μm or more and 20 μm or less.

Each of the primary particle size and the secondary particle size means a particle size with which a volume integrated value becomes 50% in a particle size distribution obtained by a laser diffraction particle size distribution measuring apparatus. As the laser diffraction particle size distribution measuring apparatus, Shimadzu SALD-300 is used, for example. For measurement, luminous intensity distribution is measured 64 times at intervals of 2 seconds. As a sample used when performing the particle size distribution measurement, a dispersion obtained by diluting the negative electrode active material particles by N-methyl-2-pyrrolidone such that the concentration becomes 0.1 wt % to 1 wt % is used. Alternatively, a measurement sample obtained by dispersing 0.1 g of a negative electrode active material in 1 to 2 ml of distilled water containing a surfactant is used.

In addition to the negative electrode active material, the negative electrode active material-containing layer may contain a conductive agent, a binder, and the like. A conductive agent is added as necessary in order to increase the current-collecting performance and to suppress the contact resistance between the active material and the current collector. The binder has an function of binding the active material, the conductive agent, and the current collector.

Examples of the conductive agent include carbonaceous materials such as acetylene black, Ketjen black, carbon nanofiber, carbon nanotube, graphite, and coke. The conductive agent may be of one type, or two or more types may be used in mixture.

A binder is added in order to fill gaps of a dispersed active material, or to bind the active material and a negative electrode current collector to each other. Examples of the binder include polytetrafluoroethylene; PTFE, polyvinylidenefluoride; PVdF, fluorine-based rubber, styrene-butadiene rubber, a polyacrylic acid compound, an imide compound, carboxylmethylcellulose; CMC, and salt of CMC. One of these may be used as a binder, or alternatively, two or more thereof may be combined with each other and used as a binder.

The mixing ratios of the conductive agent and the binder in the negative electrode active material-containing layer are preferably in a range of 1 part by weight or more and 20 parts by weight or less, and in a range of 0.1 part by weight or more and 10 parts by weight or less, respectively, with respect to 100 parts by weight of the active material. If the mixing ratio of the conductive agent is 1 part by weight or more, the conductivity of the negative electrode can be improved. If the mixing ratio of the conductive agent is 20 parts by weight or less, decomposition of the aqueous electrolyte on the conductive agent surface can be reduced. When the mixing ratio of the binder is 0.1 part by weight or more, sufficient electrode strength is obtained, and when the mixing ratio of the binder is 10 parts by weight or less, an insulating portion of the electrode can be decreased.

The negative electrode can be obtained by, for example, the following method. First, the active material, the conductive agent, and the binder are suspended in an appropriate solvent to prepare a slurry. Next, the slurry is applied to one surface or both surfaces of the current collector. The coating on the current collector is dried, thereby forming an active material-containing layer. After that, pressing is performed for the current collector and the active material-containing layer formed on it. As the active material-containing layer, the mixture of the active material, the conductive agent, and the binder formed into pellets may be used.

The crystal structure and element composition of the negative electrode active material and a positive electrode active material described later can be confirmed by, for example, powder X-ray diffraction (XRD) measurement and inductively coupled plasma (ICP) emission spectroscopy described below.

<Powder X-Ray Diffraction Measurement of Active Materials>

The powder X-ray diffraction measurement of the active material can be performed, for example, as follows. First, the target sample is ground until an average particle size reaches about 5 μm. A holder part, which has a depth of 0.2 mm and is formed on a glass sample plate, is filled with the ground sample. At this time, care should be taken to fill the holder part sufficiently with the sample. In addition, Precaution should be taken to perform the filling with the amount of the sample neither being excessive nor insufficient such that cracks, voids, and the like do not occur. Next, another glass plate is pushed from the outside to flatten a surface of the sample filling the holder part. Precaution should be taken not to cause a recess or a protrusion from a reference plane of the holder due to an excessive or insufficient amount of filling.

Next, the glass plate filled with the sample is set in a powder X-ray diffractometer, and a diffraction pattern (X-Ray diffraction pattern (XRD pattern)) is obtained using Cu-Kα rays.

Incidentally, there is a case where the orientation of the sample increases depending on a particle shape of the sample. In the case where there is high degree of orientation in the sample, there is the possibility of deviation of the peak or variation in an intensity ratio, depending on the filling state of the sample. The sample whose orientation is remarkably high in this manner is measured using a glass capillary. Specifically, a sample is inserted into a capillary, and this capillary is placed on a rotary sample stage and measured. It is possible to alleviate the orientation with the above-described measuring method. It is preferable to use a capillary formed of Lindeman glass having a diameter of 1 mm to 6 mmφ as the glass capillary.

In the case of performing the powder X-ray diffraction measurement for the active material included in a secondary battery or an electrode, the powder X-ray diffraction measurement can be performed, for example, as follows.

First, in order to grasp the crystal state of the active material, lithium ions are fully released from the active material. For example, when the active material is used in the negative electrode, the battery is brought into a fully discharged state. The battery can be brought into the discharged state by, for example, repeating the discharge of the battery at 0.1 C current at 25° C. until a rated end voltage or a battery voltage reaches 1.0 V a plurality of times, so that the current value at the time of discharge becomes 1/100 or less of the rated capacity. There may be lithium ions remaining even in the discharged state.

The battery is then disassembled, and the electrodes are removed and washed with a suitable solvent. As the suitable solvent, for example, pure water or ethyl methyl carbonate can be used. When the electrode is not sufficiently cleaned, an impurity phase such as lithium carbonate or lithium fluoride may be mixed due to the influence of lithium ions remaining in the electrode. In this case, a peak derived from a metal foil, an electro-conductive agent, a binder, and the like, which are the current collector, are measured and grasped in advance using EDX. Of course, this operation can be omitted when these are known in advance. When the peak of the current collector and the peak of the active material overlap, it is desirable to perform measurement by peeling the active material-containing layer off the current collector. This is for separating the overlapping peaks at the time of quantitatively measuring peak intensity. The active material-containing layer may be physically peeled. The active material-containing layer tends to be peeled when an ultrasonic wave is applied to the active material-containing layer in an appropriate solvent. When ultrasonic treatment is performed to peel the active material-containing layer off the current collector, an electrode body powder (including the active material, the conductive agent, and the binder) can be recovered by volatilizing the solvent. Collected electrode material powder is subjected to the measurement by being loaded, for example, into a capillary made of Lindeman glass, whereby the powder X-ray diffraction measurement for the active material can be performed. Note that the electrode material powder collected by performing ultrasonic treatment can also be served for a variety of analyses other than the powder X-ray diffraction measurement.

<ICP Emission Spectroscopy>

The composition of the active material can be analyzed using, for example, inductively coupled plasma (ICP) emission spectroscopy. At this time, an abundance ratio (molar ratio) of each element depends on sensitivity of an analyzer to be used. Hence the measured molar ratio may deviate from an actual molar ratio by an error of the measuring device. However, even when the numerical value deviates from the error range of the analyzer, the performance of the active material according to the embodiment can be exhibited sufficiently.

For measuring the composition of the active material incorporated in the battery by the ICP emission spectroscopy, specifically, the following procedure is performed.

First, the electrode containing the active material to be measured is taken out from the secondary battery by the procedure described in the section of the powder X-ray diffraction measurement, and then washed. From the washed electrode, the portion containing the electrode active material such as the active material-containing layer is peeled. The portion containing the electrode active material can be peeled by, for example, irradiating the portion with ultrasonic waves. As a specific example, for example, by placing the electrode in pure water or ethyl methyl carbonate placed in a glass beaker and vibrating the electrode in an ultrasonic washer, it is possible to peel the active material-containing layer containing the electrode active material off the electrode current collector.

Next, the peeled portion is heated in an atmosphere for a short time (e.g., at 500° C. for about 1 hour) to burn off unnecessary components such as the binder component and carbon. By dissolving this residue with acid, a liquid sample containing an active material can be prepared. At this time, hydrochloric acid, nitric acid, sulfuric acid, hydrogen fluoride, and the like can be used as the acid.

The composition in the active material can be seen by subjecting this liquid sample to ICP analysis.

(2) Negative Electrode Lead

The negative electrode lead is a member that is electrically connected to the negative electrode current collector. The negative electrode lead has, for example, a plate-like or foil-like form. The negative electrode lead may be a member made of metal. The negative electrode lead may be a metal plate containing aluminum, an aluminum alloy, copper, or nickel. The negative electrode lead may be a metal plate made of aluminum, an aluminum alloy, copper, or nickel. The aluminum alloy may contain at least one element selected from magnesium (Mg), titanium (Ti), zinc (Zn), manganese (Mn), iron (Fe), copper (Cu), and silicon (Si).

For example, the negative electrode lead, which is a strip-shaped metal plate, has one end electrically connected to the negative electrode current collector and the other end electrically connected to the negative electrode terminal in the storage space of the container member. A part of the negative electrode terminal is pulled out from the storage space of the container member toward the outside.

The material (base material) constituting the negative electrode lead may be the same as or different from the material (base material) constituting the negative electrode current collector. The material (base material) constituting the negative electrode lead is preferably the same as the material (base material) constituting the negative electrode current collector. When these are the same as each other, the affinity at the joint (hereinafter referred to as “negative electrode joint”) between the negative electrode current collector and the negative electrode lead can be increased and the contact resistance can be reduced. Therefore, it is possible to reduce the occurrence of the electrolysis of water at the negative electrode joint.

The materials of the base material constituting the negative electrode lead may be the same as or different from the materials of the base material constituting the positive electrode lead described later.

The thickness of the negative electrode lead is in the range of 0.1 mm to 3.0 mm according to one example, and is in the range of 0.2 mm to 0.5 mm according to another example. The thickness in the range of 0.2 mm to 0.5 mm is a thickness that facilitates the formation of the joint by various joining methods. Further, when the negative electrode lead is in this range, the electric resistance can be made relatively low.

When aluminum or an aluminum alloy is used as the negative electrode lead, the energy density can be increased because aluminum is the lightest metal among metals. Aluminum or an aluminum alloy is also preferable in terms of low cost. When copper or nickel is used as the negative electrode lead, the conductivity of these metals is high, and thus a battery with low resistance can be obtained. It also has the advantage of being easily processed.

At least a part of the surface of the negative electrode lead has a negative electrode lead coating. It is preferable that the entire surface of the negative electrode lead have a negative electrode lead coating. According to one example, the negative electrode lead coating is thicker than the negative electrode current collector coating.

The negative electrode lead coating contains at least one selected from the group consisting of aluminum oxide, aluminum oxyhydroxide, chromium-containing compounds, and zinc-containing compounds. The negative electrode lead coating may be a stacked coating containing one of these compounds. For example, the negative electrode lead coating may have a stacked structure of a coating containing aluminum oxide and a coating containing a chromium-containing compound.

The thickness of the negative electrode lead coating is, for example, in the range of 2 μm or more and 100 μm or less, preferably in the range of more than 5 μm and 50 μm or less. The thickness of the negative electrode lead coating may be in the range of 10 μm or more and 30 μm or less. When the thickness of the negative electrode lead coating is in the range of 5 μm or more and 50 μm or less, it is possible to achieve both a high effect of suppressing side reactions and low resistance.

The secondary battery according to the embodiment includes the joint for electrically connecting the negative electrode current collector to the negative electrode lead. As described above, the joint is referred to as “negative electrode joint”. The negative electrode current collector is joined to the negative electrode lead by welding or the like. When the negative electrode current collector includes a negative electrode tab portion, the negative electrode lead may be joined to the negative electrode tab portion.

The method of joining the negative electrode current collector to the negative electrode lead is not particularly limited. For example, the negative electrode joint may be a portion where the negative electrode current collector and the negative electrode lead are welded as described above, or a portion where the negative electrode current collector and the negative electrode lead are crimped using a holding member or the like, or a portion where the negative electrode current collector and the negative electrode lead are joined by caulking. The bonding between the negative electrode current collector and the negative electrode lead is performed by a method selected from the group consisting of, for example, ultrasonic welding, resistance welding, laser welding, and bonding by crimping. The joint between the negative electrode lead and the negative electrode terminal can also be formed by welding, crimping using a holding member, or joining by caulking.

It is preferable that at least a part of the negative electrode joint be covered with a water-repellent member. The negative electrode joint is a portion where the base material of the negative electrode current collector and/or the negative electrode lead are/is easily exposed when the negative electrode current collector and the negative electrode lead are joined to each other. When the base material is exposed, side reactions between the base material and the aqueous electrolyte are likely to occur.

When the negative electrode joint is covered with the water-repellent member, the contact probability between the base material and the aqueous electrolyte can be reduced. As a result, it is possible to suppress a decrease in the charge/discharge efficiency of the secondary battery even when the charge/discharge cycle is repeated a plurality of times. When two or more negative electrode joints are present, it is preferable that all of these joints be covered with the water-repellent member. From the viewpoint of the adhesion and coating property of the water-repellent member, it is preferable that the water-repellent member be provided by a method of applying a water-repellent material to the negative electrode joint and then heating and fusing the water-repellent material. When the water-repellent member is provided by heating and fusing the water-repellent material, the adhesion of the water-repellent member to the joint is improved, and a wide range of the joint can be easily covered.

The water-repellent member contains at least one water-repellent material selected from the group consisting of, for example, polytetrafluoroethylene (PTFE), tetrafluoroethylene-hexafluoropropylene copolymer (FEP), polypropylene, polyethylene, polyimide, polystyrene, silicone, and epoxy resin. The water-repellent member may be made of one kind of water-repellent material, or may be made of a mixture of two or more kinds of water-repellent materials.

The thickness of the water-repellent member is preferably relatively large so that water impregnated in the water-repellent member does not easily reach the joint. However, when the thickness of the water-repellent member is too large, the volumetric energy density of the secondary battery decreases, and the handleability when the battery is assembled decreases, which are not preferable. The thickness of the water-repellent member is, for example, in the range of 0.1 μm to 500 μm.

(3) Negative Electrode Terminal

The negative electrode terminal may be electrically connected to the negative electrode lead. The negative electrode terminal can be formed of a material that is electrochemically stable and has conductivity at the Li insertion/extraction potential of the above-mentioned negative electrode active material. Specifically, examples of the material of the negative electrode terminal include aluminum alloys containing zinc, copper, nickel, stainless steel, or aluminum, or at least one element selected from the group consisting of Mg, Ti, Zn, Mn, Fe, Cu, and Si. The negative electrode terminal is preferably made of the same material as the negative electrode current collector in order to reduce the contact resistance with the negative electrode lead.

When a part of the negative electrode lead can be pulled out to the outside of an outer layer member, the negative electrode terminal may be omitted.

(4) Positive Electrode

The positive electrode may include a positive electrode current collector and a positive electrode active material-containing layer supported on at least one main surface of the positive electrode current collector.

The description of the positive electrode current collector is common to the description of the negative electrode current collector described above. Specifically, the same description as the description of the negative electrode current collector described above is applied to the description of the material, thickness, protective coating, and the like of the positive electrode current collector.

As the positive electrode active material, a compound whose lithium ion insertion/extraction potential is 2.5 V (vs. Li/Li⁺) to 5.5 V (vs. Li/Li⁺) as a potential based on metal lithium can be used. The positive electrode may contain one type of positive electrode active material or may contain two or more types of positive electrode active materials.

Examples of the positive electrode active material include a lithium manganese composite oxide, a lithium nickel composite oxide, a lithium cobalt aluminum composite oxide, a lithium nickel cobalt manganese composite oxide, a spinel type lithium manganese nickel composite oxide, a lithium manganese cobalt composite oxide, a lithium iron oxide, a lithium fluorinated iron sulfate, a phosphate compound having an olivine crystal structure (for example, LiₓFePO₄ (0<x≤1), LiₓMnPO₄ (0<x≤1)), and the like. The phosphate compound having an olivine crystal structure has excellent thermal stability.

Examples of the positive electrode active material capable of obtaining a high positive electrode potential are a lithium manganese composite oxide having a spinel structure such as LiₓMn₂O₄ (0<x≤1) or LiₓMnO₂ (0<x≤1), a lithium nickel aluminum composite oxide such as LiₓNi_{1-y}Al_{y}O₂ (0<x≤1, and 0<y<1), a lithium cobalt composite oxide such as LiₓCoO₂ (0<x≤1), a lithium nickel cobalt composite oxide such as LiₓNi_{1-y-z}Co_{y}Mn_{z}O₂ (0<x≤1, 0<y<1, and 0≤z<1), a lithium manganese cobalt composite oxide such as LiₓMn_{y}Co_{1-y}O₂ (0<x≤1, and 0<y<1), a spinel type lithium manganese nickel composite oxide such as LiₓMn_{1-y}Ni_{y}O₄ (0<x≤1, 0<y<2, and 0<1-y<1), a lithium phosphorus oxide such as having an olivine structure such as LiₓFePO₄ (0<x≤1), LiₓFe_{1-y}Mn_{y}PO₄ (0<x≤1, 0≤y≤1), or LiₓCoPO₄ (0<x≤1), and a fluorinated iron sulfate (for example, LiₓFeSO₄F (0<x≤1)).

The positive electrode active material is preferably at least one material selected from the group consisting of a lithium cobalt composite oxide, a lithium manganese composite oxide, and a lithium phosphorus oxide having an olivine structure. The operating potentials of these active materials are 3.5 V (vs. Li/Li⁺) to 4.2 V (vs. Li/Li⁺). That is, the operating potentials of these active materials are relatively high. When these positive electrode active materials are used in combination with the above-described negative electrode active material such as a spinel type lithium titanate or an anatase type titanium oxide, a high battery voltage can be obtained.

The positive electrode active material is contained in the positive electrode in a form of, for example, particles. The positive electrode active material particles can be single primary particles, secondary particles as the aggregates of primary particles, or a mixture of primary particles and secondary particles. The shape of a particle is not particularly limited and can be, for example, spherical, elliptical, flat, or fibrous.

The average particle size (diameter) of the primary particles of the positive electrode active material is preferably 10 μm or less, and more preferably 0.1 μm to 5 μm. The average particle size (diameter) of the secondary particles of the positive electrode active material is preferably 100 μm or less, and more preferably 10 μm to 50 μm.

The primary particle size and the secondary particle size of the positive electrode active material can be measured by the same method as that for the negative electrode active material particles.

In addition to the positive electrode active material, the positive electrode active material-containing layer may contain a conductive agent, a binder, and the like. A conductive agent is added as necessary in order to increase the current-collecting performance and to suppress the contact resistance between the active material and the current collector. The binder has an action of binding the active material, the conductive agent, and the current collector.

Examples of the conductive agent include carbonaceous materials such as acetylene black, Ketjenblack, carbon nanofibers, carbon nanotubes, graphite, and coke. As the conductive agent, one kind may be used, or two or more kinds may be mixed and used.

In the positive electrode active material-containing layer, preferred percentages of mixing of the positive electrode active material and the binder are within the range from 80% by mass to 98% by mass, and from 2% by mass to 20% by mass, respectively.

With the content of the binder adjusted to 2% by mass or more, a sufficient level of electrode strength is obtainable. The binder can also function as an insulator. Hence, with the content of binder adjusted to 20% by mass or less, the amount of insulator contained in the electrode decreases, and thereby the internal resistance may be lowered.

In a case where the conductive agent is added, percentages of mixing of the positive electrode active material, the binder, and the conductive agent are preferably within the range from 77% by mass to 95% by mass, from 2% by mass to 20% by mass, and from 3% by mass to 15% by mass, respectively.

With the amount of conductive agent adjusted to 3% by mass or more, the aforementioned effects may be demonstrated. Meanwhile, with the amount of conductive agent adjusted to 15% by mass or less, percentage of the conductive agent possibly brought into contact with the electrolyte may be reduced. With the percentage suppressed low, the electrolyte may be suppressed from being decomposed during storage at high temperature.

The positive electrode can be obtained by, for example, the following method. First, the active material, the conductive agent, and the binder are suspended in an appropriate solvent to prepare a slurry. Next, the slurry is applied to one surface or both surfaces of the current collector. The coating on the current collector is dried, thereby forming an active material-containing layer. After that, pressing is performed for the current collector and the active material-containing layer formed on it. As the active material-containing layer, the mixture of the active material, the conductive agent, and the binder formed into pellets may be used.

(5) Positive Electrode Lead

The positive electrode lead is a member that is electrically connected to the positive electrode current collector.

The description of the positive electrode lead is common to the description of the negative electrode lead described above. Specifically, the same description as that of the negative electrode lead described above is applied to the description of the material, thickness, protective coating, and the like of the positive electrode lead.

The material (base material) constituting the positive electrode lead may be the same as or different from the material (base material) constituting the positive electrode current collector. The material (base material) constituting the positive electrode lead is preferably the same as the material (base material) constituting the positive electrode current collector. In this case, it is possible to increase the affinity at the joint (hereinafter referred to as “positive electrode joint”) between the positive electrode current collector and the positive electrode lead and reduce the contact resistance. Therefore, it is possible to reduce the occurrence of the electrolysis of water at the positive electrode joint.

The secondary battery according to the embodiment includes the joint for electrically connecting the positive electrode current collector to the positive electrode lead. As described above, the joint is referred to as “positive electrode joint”. The positive electrode current collector is joined to the positive electrode lead by welding or the like. When the positive electrode current collector includes a positive electrode tab portion, the positive electrode lead may be joined to the positive electrode tab portion.

The method of joining the positive electrode current collector to the positive electrode lead is not particularly limited. For example, the positive electrode joint may be a portion where the positive electrode current collector and the positive electrode lead are welded as described above, or a portion where the positive electrode current collector and the positive electrode lead are crimped using a holding member or the like, or a portion where the positive electrode current collector and the positive electrode lead are joined by caulking. The bonding between the positive electrode current collector and the positive electrode lead is performed by a method selected from the group consisting of, for example, ultrasonic welding, resistance welding, laser welding, and bonding by crimping. The joint between the positive electrode lead and the positive electrode terminal can also be formed by welding, crimping using a holding member or the like, or joining by caulking.

It is preferable that at least a part of the positive electrode joint be covered with a water-repellent member. The positive electrode joint is a portion where the base material of the positive electrode current collector and/or the base material the positive electrode lead are/is easily exposed when the positive electrode current collector and the positive electrode lead are joined. When the base material is exposed, side reactions between the base material and the aqueous electrolyte are likely to occur. When the positive electrode joint is covered with the water-repellent member, the contact probability between the base material and the aqueous electrolyte can be reduced. As a result, it is possible to suppress a decrease in the charge/discharge efficiency of the secondary battery even when the charge/discharge cycle is repeated a plurality of times. When two or more positive electrode joints are present, it is preferable that all of these joints be covered with the water-repellent member.

As the water-repellent member, the same member as that described for the negative electrode joint can be used.

(6) Positive Electrode Terminal

The positive electrode terminal can be formed of a material that is electrically stable and has conductivity in a potential range (vs. Li/Li⁺) of 2.5 V or more and 5.5 V or less with respect to the redox potential of lithium. Examples of the material of the positive electrode terminal include aluminum or aluminum alloys containing at least one element selected from the group consisting of Mg, Ti, Zn, Mn, Fe, Cu, and Si. The positive electrode terminal is preferably formed of the same material as the positive electrode current collector in order to reduce the contact resistance with the positive electrode current collector.

When a part of the positive electrode lead can be pulled out to the outside of an outer layer member, the positive electrode terminal may be omitted.

(7) Aqueous Electrolyte

The aqueous electrolyte contains an aqueous solvent and an electrolyte salt. The aqueous electrolyte is, for example, a liquid. The liquid aqueous electrolyte is an aqueous solution prepared by dissolving an electrolyte salt as a solute in an aqueous solvent. The amount of the aqueous solvent in the aqueous solution is preferably 1 mol or more, more preferably 3.5 mol or more, with respect to 1 mol of the salt as a solute.

As the aqueous solvent, a solution containing water can be used. The solution containing water may be pure water or a mixed solvent of water and an organic solvent. The aqueous solvent contains, for example, water in a proportion of 50% or more by volume.

Whether or not water is contained in each of the first aqueous electrolyte and the second aqueous electrolyte can be confirmed by gas chromatography-mass spectrometry (GC-MS) measurement. Further, such a salt concentration and a water content in each of the aqueous electrolytes can be measured, for example, by inductively coupled plasma (ICP) emission spectrometry or the like. The aqueous electrolyte is weighed by a prescribed amount, and the concentration of salt contained therein is calculated, whereby a mol concentration (mol/L) can be calculated. Further, a specific gravity of the aqueous electrolyte is measured, whereby the number of moles of each of the solute and the solvent can be calculated.

The aqueous electrolyte may be a gel electrolyte. The gel electrolyte is prepared by mixing and complexing the above-mentioned liquid aqueous electrolyte and a polymer compound. Examples of the polymer compound include polyvinylidene fluoride (PVdF), polyacrylonitrile (PAN), polyethylene oxide (PEO), and the like.

As the electrolyte salt, for example, a lithium salt, a sodium salt, or a mixture thereof can be used. As the lithium salt and the sodium salt, the same salts as those that can be contained in a solid electrolyte layer can be used. The lithium salt preferably contains LiCl. When LiCl is used, the lithium ion concentration of the aqueous electrolyte can be increased. Further, it is preferable that the lithium salt contain at least one of LiSO₄ and LiOH in addition to LiCl.

The molar concentration of the electrolyte salt in the aqueous electrolyte may be 3 mol/L or more, 6 mol/L or more, or 12 mol/L or more. According to one example, the molar concentration of the electrolyte salt in the aqueous electrolyte is 14 mol/L or less. When the concentration of the electrolyte salt in the aqueous electrolyte is high, the electrolysis of the aqueous solvent in the negative electrode is likely to be suppressed, and the amount of hydrogen generated from the negative electrode tends to be small.

The aqueous electrolyte preferably contains at least one selected from a chlorine ion (Cl⁻), a hydroxide ion (OH⁻), a sulfate ion (SO₄²⁻), and a nitrate ion (NO₃⁻) as anion species.

The pH of the aqueous electrolyte is preferably 3 or more and 14 or less, and more preferably 4 or more and 13 or less. When different electrolytes are used for the electrolyte on the negative electrode side and the electrolyte on the positive electrode side, the pH of the electrolyte on the negative electrode side is preferably in the range of 3 or more and 14 or less, and the pH of the electrolyte on the positive electrode side is preferably in the range of 1 or more and 8 or less.

When the pH of the electrolyte on the negative electrode side is in the above range, the hydrogen generation potential at the negative electrode is lowered, so that the generation of hydrogen at the negative electrode is suppressed. This improves the storage performance and cycle life performance of the battery. When the pH of the electrolyte on the positive electrode side is in the above range, the oxygen generation potential at the positive electrode is high, so that the generation of oxygen at the positive electrode is reduced. This improves the storage performance and cycle life performance of the battery. The pH of the electrolyte on the positive electrode side is more preferably in the range of 3 or more and 7.5 or less.

The aqueous electrolyte may contain a surfactant. Examples of the surfactant include nonionic surfactants such as polyoxyalkylene alkyl ether, polyethylene glycol, polyvinyl alcohol, thiourea, 3,3′-dithiobis (1-propane sulfonic acid) disodium, dimercaptothiadiazole, boric acid, oxalic acid, malonic acid, saccharin, sodium naphthalene sulfonate, gelatin, potassium nitrate, aromatic aldehydes, and heterocyclic aldehydes. The surfactant may be used alone or two or more types of surfactants may be mixed and used.

(8) Separator

A separator may be disposed between a positive electrode and a negative electrode. When the separator is constituted of an insulating material, electrical contact between the positive electrode and the negative electrode can be prevented. It is desirable to use a separator having a shape allowing an electrolyte to move between the positive electrode and the negative electrode. Examples of the separator include nonwoven fabrics, films, and paper. Examples of materials forming the separator include polyolefin, such as polyethylene and polypropylene, and cellulose. Preferable examples of the separator include nonwoven fabrics containing cellulose fibers and porous films containing polyolefin fibers. The porosity of the separator is preferably 60% or more. A fiber diameter is preferably 10 μm or less. When the fiber diameter is 10 μm or less, an affinity of the separator with an electrolyte is enhanced, so that battery resistance can be reduced. A more preferable range of the fiber diameter is 3 μm or less. In a cellulose fiber containing nonwoven fabric having a porosity of 60% or more, impregnation of an electrolyte is good, and high output performance can be exhibited from low temperature to high temperature. The separator does not react with a negative electrode in long term charged storage, float charging, and over-charge, and a short-circuit between the negative electrode and the positive electrode due to dendrite precipitation of lithium metal does not occur. A more preferable range is 62% to 80%.

It is preferable that the separator has a thickness of 20 μm to 100 μm and a density of 0.2 g/cm³ to 0.9 g/cm³. If the thickness and the density of the separator are in these ranges, mechanical strength and a reduction in battery resistance can be balanced, so that a secondary battery in which an internal short-circuit is suppressed by a high output can be provided. Heat shrinkage of the separator under a high temperature environment is small, and good high temperature storage performance can be exhibited.

As a separator, a solid electrolyte layer including solid electrolyte particles can also be used. The solid electrolyte layer may include one type of solid electrolyte particles or may include plural types of solid electrolyte particles. The solid electrolyte layer may be a solid electrolyte composite film including solid electrolyte particles. The solid electrolyte composite film is obtained by, for example, forming solid electrolyte particles into a film shape using a polymer material. The solid electrolyte layer may contain at least one selected from the group consisting of a plasticizer and an electrolyte salt. When the solid electrolyte layer contains an electrolyte salt, for example, alkali metal ion conductivity of the solid electrolyte layer can be further enhanced.

Examples of a polymer material include polyether type, polyester type, polyamine type, polyethylene type, silicone type and polysulfide type.

As the solid electrolyte, an inorganic solid electrolyte is preferably used. As the inorganic solid electrolyte, for example, an oxide-based solid electrolyte or a sulfide-based solid electrolyte can be used. As the oxide-based solid electrolyte, a lithium phosphate solid electrolyte having a NASICON structure and represented by a general formula LiM₂(PO₄)₃ is preferably used. M in the formula is preferably at least one element selected from the group consisting of titanium (Ti), germanium (Ge), strontium (Sr), zirconium (Zr), tin (Sn), and aluminum (Al). The element M preferably includes Al and one of Ge, Zr, and Ti.

Detailed examples of the lithium phosphate solid electrolyte having the NASICON structure include LATP (Li₁₊ₓAlₓTi₂₋ₓPO₄)₃) Li₁₊ₓAlₓGe₂₋ₓ(PO₄)₃, and Li₁₊ₓAlₓZr₂₋ₓ(PO₄)₃. In the above formula, x falls within the range of 0<x≤5, x preferably falls within the range of 0<x≤2, x more preferably falls within the range of 0.1≤x≤0.5. As the solid electrolyte, LATP is preferably used. LATP is excellent in waterproofness and hardly causes hydrolysis in the secondary battery.

As the oxide-based solid electrolyte, LIPON (Li_{2.9}PO_{3.3}N_{0.46}) in an amorphous state or LLZ (Li₇La₃Zr₂O₁₂) having a garnet structure may be used.

As the solid electrolyte, a sodium containing solid electrolyte may be used. The sodium containing solid electrolyte is excellent in the ionic conductivity of sodium ions. As the sodium containing solid electrolyte, β-alumina, a sodium phosphorus sulfide, a sodium phosphorus oxide, or the like can be used. The sodium ions containing solid electrolyte preferably has a glass-ceramic form.

A composite solid electrolyte layer, which includes a composite layer having the aforementioned polymer material and the aforementioned solid electrolyte, and a porous self-supporting film, may be used as the separator. The porous self-supporting film includes a self-supporting film formed of polyolefin such as the aforementioned polyethylene or polypropylene, or cellulose.

(9) Container Member

As the container member storing the positive electrode, the negative electrode, and the electrolyte, a metal container, a stacked film container, a resin container made of polyethylene, polypropylene, or the like can be used.

As the metal container, a metal can made of nickel, iron, stainless steel, or the like and having a rectangular shape or a cylindrical shape can be used.

The board thickness of each of the resin container and the metal container preferably falls within the range of 0.05 mm to 1 mm. The board thickness is more preferably 0.5 mm or less, and much more preferably 0.3 mm or less.

As the laminated film, for example, a multilayered film formed by covering a metal layer with a resin layer can be used. Examples of the metal layer include a stainless steel foil, an aluminum foil, and an aluminum alloy foil. As the resin layer, a polymer such as polypropylene (PP), polyethylene (PE), nylon, or polyethylene terephthalate (PET) can be used. The thickness of the laminated film preferably falls within the range of 0.01 mm to 0.5 mm. The thickness of the laminated film is more preferably 0.2 mm or less.

The secondary battery according to the present embodiment can be used in various forms such as a square shape, a cylindrical shape, a flat type, a thin type, and a coin type. Further, the secondary battery may have a bipolar structure. This has the advantage that multiple series of cells can be produced with a single cell.

(Method of Producing Protective Coating)

The protective coating that can be contained in the negative electrode current collector, the negative electrode lead, the positive electrode current collector, and the positive electrode lead can be formed by, for example, an anodizing method, boehmite treatment, chromate treatment, zincate treatment, or a combination of two or more of these methods described below. For example, after an object to be treated is anodized, the chromate treatment may be further performed.

When the anodizing method or the boehmite treatment is performed, it is preferable to sufficiently perform alkaline degreasing on the surface of the object to be treated before the production. By this degreasing, impurities on the surface of the object to be treated and a natural oxide coating can be removed. Therefore, in the anodizing method or the boehmite treatment, when the object to be treated is immersed in a solution, the reattachment of impurities and the reoxidation of the surface can be suppressed.

(Anodizing Method)

The anodizing method is a method in which an oxide coating is formed on the surface of the object to be treated by immersing the object to be treated in an electrolytic solution and applying a direct current or a high voltage using the object to be treated as an anode. The object to be treated is, for example, a current collector or a lead.

The electrolyte solution is, for example, sulfuric acid, oxalic acid, phosphoric acid, or chromic acid. It is preferable that the electrolytic solution be previously subjected to nitrogen bubbling to sufficiently remove dissolved oxygen. When the dissolved oxygen in the electrolytic solution is sufficiently removed, the generation of pinholes due to oxidation can be suppressed.

Further, in order to prevent oxygen from being mixed into the electrolytic solution even during the anodizing treatment, it is preferable to perform this treatment in an inert atmosphere. The inert atmosphere can be, for example, a nitrogen atmosphere.

When a coating of about 15 nm or more is formed by the anodizing method, the coating can be porous. Therefore, when the object to be treated having the coating in this state is used in an aqueous secondary battery, water molecules may enter the pores and hydrogen may be generated from the pores to destroy a coating layer.

Therefore, it is preferable to further seal the holes. The sealing treatment can be performed, for example, by immersing the object to be treated having the above-mentioned coating in boiling pure water. By this sealing treatment, a coating containing aluminum oxide is formed so as to close the pores.

When the voltage applied by the anodizing method is reduced, the formed coating tends to be thin. When the applied voltage is increased, the coating formed tends to be thicker. That is, the thickness changes according to the applied voltage.

Therefore, in the case where the first current collector coating or the second current collector coating according to the embodiment is formed by the anodizing method, for example, it is conceivable to reduce the applied voltage. Further, in the case where the first lead coating or the second lead coating is formed, for example, it is conceivable to relatively increase the applied voltage.

(Boehmite Treatment)

The boehmite treatment is a method in which pure water or an aqueous solution containing a small amount of an alkali such as triethanolamine as an additive is boiled and the object to be treated is immersed therein to form a coating layer. When the boiled solution contains an alkali, it functions as a growth agent and promotes the formation of a boehmite layer on the surface of the object to be treated, so that a thick coating layer having sufficient coating properties can be obtained.

In the boehmite treatment, when the time for immersing the object to be treated in the boiling solution is shortened, the formed coating tends to be thin. When the object to be treated is immersed in the boiled solution for a long time, the formed coating tends to be thickened.

Therefore, when the first current collector coating or the second current collector coating according to the embodiment is formed by the boehmite treatment, for example, the time for immersing the object to be treated in the boiled solution can be considered to be shortened. Further, in the case where the first lead coating or the second lead coating is formed, for example, it is conceivable to relatively lengthen the immersion time.

Regardless of whether the anodizing method or the boehmite treatment is used, the drying of the coating after the formation of the coating is preferably natural drying. For example, it is preferable to dry the coating at a temperature of 80° C. or lower for about 1 hour. When this drying is performed at a high temperature of, for example, 100° C. or higher, dry spots may occur on the coating and the covering property may be deteriorated, which is not preferable.

(Chromate Treatment)

As the chromate treatment, any of an etching method, an electrolytic method, and a coating method can be selected, but the etching method is preferable from the viewpoint of solubility and corrosion resistance. Examples of the etching chromate treatment include chromic acid chromate treatment and phosphoric acid chromate treatment.

In the above etching chromate treatment, it is preferable to perform a chromium substitution step after performing an alkali or acid dipping step (preferably via a water washing treatment step). The chromium substitution step is preferably performed by immersing the object to be treated in a chromium bath or spraying the liquid at a temperature of 15 to 70° C. for 3 to 300 seconds.

In the chromate treatment, when the time for performing the chromium substitution step is shortened, the coating formed tends to be thin. Further, as the time for performing the chromium substitution step is lengthened, the coating formed tends to be thick.

Therefore, in the case where the first current collector coating or the second current collector coating according to the embodiment is formed by the chromate treatment, for example, it is conceivable to shorten the time for performing the chromium substitution step. Further, in the case where the first lead coating or the second lead coating is formed, for example, it is conceivable to lengthen the time for performing the chromium substitution step.

(Zincate Treatment)

The zincate treatment includes at least a step of immersing the object to be treated in a zinc bath to substitute zinc, and it is preferable that a degreasing step, an oxide coating removal (etching) step, and a smut removal step be appropriately performed as pretreatment steps. The zinc bath refers to a zinc substitution treatment bath containing at least zinc oxide and appropriately containing sodium hydroxide, Rochelle salt, and sodium sulfate as components.

The degreasing step is a step of removing oil adhering to the surface of the object to be treated, and is generally performed with an alkaline solution using a sodium salt and a surfactant. Examples of the sodium salt include sodium phosphate, sodium metaphosphate, sodium metasilicate, sodium orthophosphate, sodium carbonate, sodium bicarbonate, and the like. The sodium salt is preferably sodium phosphate, sodium metasilicate, or the like. As the surfactant, nonionic surfactants such as fatty acid diethanolamide, isopropanolamide, and polyoxyethylene fatty acid ester, and anionic surfactants such as alkylbenzene sulfonic acid and alkylallyl sulfonic acid can be used. The degreasing step is preferably performed at a temperature of 50° C. to 70° C. for 1 to 5 minutes.

The oxide coating removal (etching) step is a step of removing the oxide coating by etching aluminum or an aluminum alloy with an alkaline solution or an acid, and can be performed using sodium hydroxide, hydrochloric acid, or the like. The oxide coating removal (etching) step is preferably performed after the degreasing step (preferably via a water washing treatment step). It is preferable that the oxide coating removal step be performed at 50° C. to 60° C. for 0.5 minutes to 1 minute when sodium hydroxide is used, and be performed at 30° C. to 40° C. for 1 minute to 3 minutes when hydrochloric acid is used.

The smut removal step is a step of removing smut (aluminum oxide, aluminum) generated during the removal of the oxide coating and impurities (silicon dioxide, magnesium oxide) contained in the object to be treated. The smut removal step is preferably performed after the oxide coating removal (etching) step (preferably via a water washing treatment step). In the smut removal step, nitric acid or fluoride can be generally used, and it is preferable to perform the smut removal step at a temperature of 20° C. to 30° C. for 10 to 60 seconds.

The zinc substitution step is a step in which the remaining thin oxide coating is removed and zinc is substituted and deposited on the newly exposed active surface. The zinc substitution step is preferably performed after the smut removal step (preferably via a water washing treatment step). The zinc substitution step may be performed at 20° C. to 40° C. in 10 to 600 seconds. The zinc substitution step may be performed a plurality of times. In the case where the zinc substitution step is performed a plurality of times, it is preferable to treat the object to be treated with a nitric acid solution or the like after performing the zinc substitution step and before performing the next zinc substitution step. As a result, zinc tends to come into contact with zinc in the next zinc substitution step.

After the zinc substitution step, further electroplating may be performed to form a sufficient zinc-containing coating.

In the zincate treatment, the shorter the zinc substitution step time, and when electroplating is performed thereafter, the smaller the plating amount, the thinner the coating tends to be formed. The longer the zinc substitution step time, and when electroplating is applied thereafter, the larger the plating amount, the thicker the coating tends to be formed.

Therefore, in the case where the first current collector coating or the second current collector coating according to the embodiment is formed by the zincate treatment, for example, it is conceivable to shorten the time for performing the zinc substitution step. In the case where the first lead coating or the second lead coating is formed, it is conceivable to relatively lengthen the time for performing the zinc substitution step and/or to further perform electroplating of zinc.

(Confirmation of Composition of Protective Coating and Measurement of Thickness)

The composition and thicknesses of the first current collector coating, the first lead coating, the second current collector coating, and the second lead coating can be measured as follows.

First, the positive electrode current collector, the positive electrode lead, the negative electrode current collector, and the negative electrode lead are cut into appropriate sizes and covered with an embedding resin. Next, a sample in which the cross section of each of the members can be observed is produced by argon ion milling. This sample is observed at a magnification of 200,000 using a transmission electron microscope (TEM). In addition, as elemental analysis, energy dispersive X-ray (EDX) mapping using an energy dispersive X-ray spectrometer (EDS) is performed. By these analyses, it can be confirmed whether each of the members has a protective coating. In this case, the protective coating refers to at least one selected from the group consisting of aluminum oxide, aluminum oxyhydroxide, chromium-containing compounds, and zinc-containing compounds.

In addition, the thickness of the protective coating of each of the members can be clearly observed by this observation. In the case where the thickness of the protective coating is measured, thicknesses of the protective coating are measured at any five positions in the visual field, and the average value of the thicknesses is calculated.

In order to confirm the composition of the protective coating, elemental analysis in the depth direction may be separately performed by Auger electron spectroscopy. For example, when the protective coating to be measured is aluminum oxide or aluminum oxyhydroxide, the ratio of the Al element and the O element can be found by Auger electron spectroscopy. Therefore, the composition of the protective coating can be analyzed based on the results of TEM-EDX and the results of Auger electron spectroscopy. Further, when the protective coating contains a chromium-containing compound or a zinc-containing compound, the thickness of the protective coating can be analyzed based on not only the results of TEM-EDX but also the results of Auger electron spectroscopy.

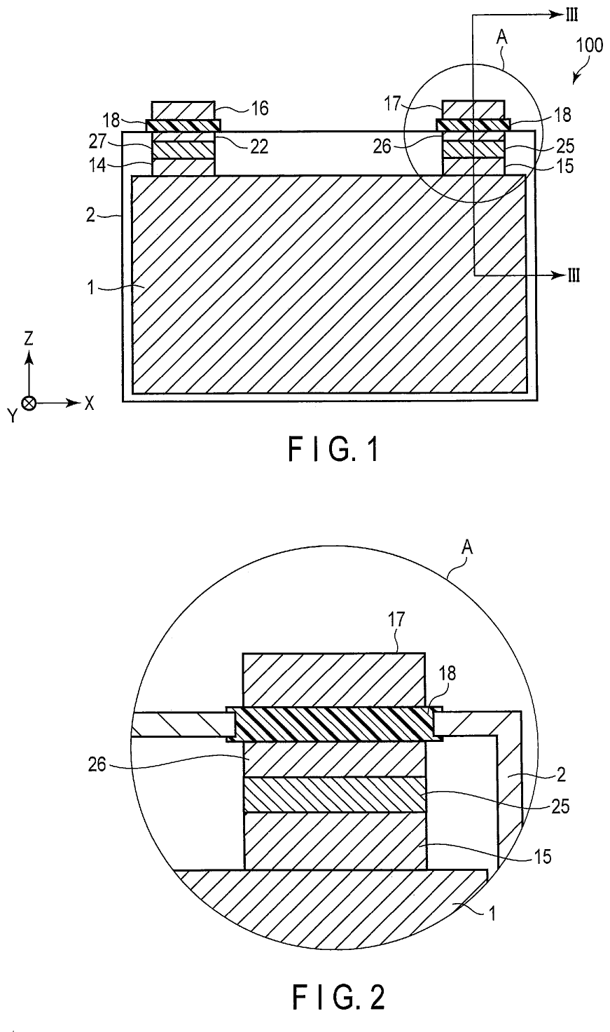

Subsequently, the secondary battery according to the embodiment will be described with reference to FIGS. 1 to 11.

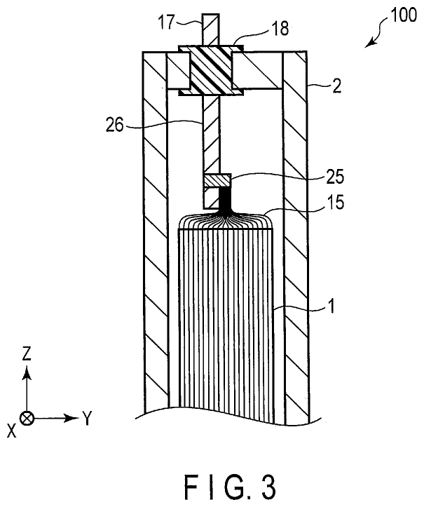

FIG. 1 is a cross-sectional view schematically showing an example of a square secondary battery according to the embodiment. FIG. 2 is an enlarged cross-sectional view showing a part A shown in FIG. 1. FIG. 3 is a cross-sectional view taken along line of the square secondary battery shown in FIG. 1. FIGS. 1 and 2 show a case where the square secondary battery according to an example is observed from its front. FIG. 3 shows a case where the square secondary battery according to the example is observed from its side.

The secondary battery 100 includes an electrode group 1, a container member 2, and an aqueous electrolyte (not shown). The electrode group 1 and the aqueous electrolyte are stored in the storage space of the container member 2. The container member 2 has a square tube shape with a bottom. The secondary battery 100 includes a positive electrode current collector 14 and a negative electrode current collector 15 as a part of the electrode group 1. The secondary battery 100 further includes a positive electrode lead 22, a joint 27 (positive electrode joint) of a positive electrode tab 14 and the positive electrode lead 22, a negative electrode lead 26, a joint 25 (negative electrode joint) of a negative electrode tab 15 and the negative electrode lead 26, a gasket 18, a positive electrode terminal 16, and a negative electrode terminal 17.

The electrode group 1 has, for example, a structure in which a positive electrode and a negative electrode are wound in a spiral shape so as to have a flat shape with a separator interposed therebetween. Alternatively, the electrode group 1 has a structure in which a plurality of positive electrodes, negative electrodes, and separators are stacked in the order of positive electrode, separator, negative electrode, and separator. FIGS. 1 to 3 show, as an example, a case where the electrode group 1 has a wound structure. The winding axis of the winding type electrode group extends parallel to the Z direction. Regardless of the structure of the electrode group 1, it is desirable that the separator is arranged in the outermost layer of the electrode group 1 in order to avoid contact between the electrodes and a metal container 20. The electrode group 1 holds an aqueous electrolyte (not shown).

As shown in FIGS. 1 to 3, the negative electrode included in the electrode group 1 includes a plurality of negative electrode tabs 15 protruding in the Z direction from one side of the negative electrode current collector. The plurality of negative electrode tabs 15 are provided so that their positions overlap after the electrode group is wound. Further, the positive electrode included in the electrode group 1 includes a plurality of positive electrode tabs 14 protruding in the Z direction from one side of the positive electrode current collector. The plurality of positive electrode tabs 14 are provided so that their positions overlap after the electrode group is wound.

The lid of the metal container 20 has an opening through which the positive electrode terminal 16 or the positive electrode lead 22 can pass, and an opening through which the negative electrode terminal 17 or the negative electrode lead 26 can pass. The positive electrode terminal 16 and the negative electrode terminal 17 are fixed to these openings via the gasket 18 which is an insulating member.

As shown in FIG. 3, the plurality of negative electrode tabs 15 are bundled at their ends and then joined to the negative electrode lead 26. The joint 25 between the plurality of negative electrode tabs 15 and the negative electrode lead 26 is formed by, for example, welding. Although not shown, the positive electrode joint 27 has a similar structure. That is, the plurality of positive electrode tabs 14 are bundled at their ends and then joined to the positive electrode lead 22. The joint 25 between the plurality of positive electrode tabs 14 and the positive electrode lead 22 is formed by, for example, welding.

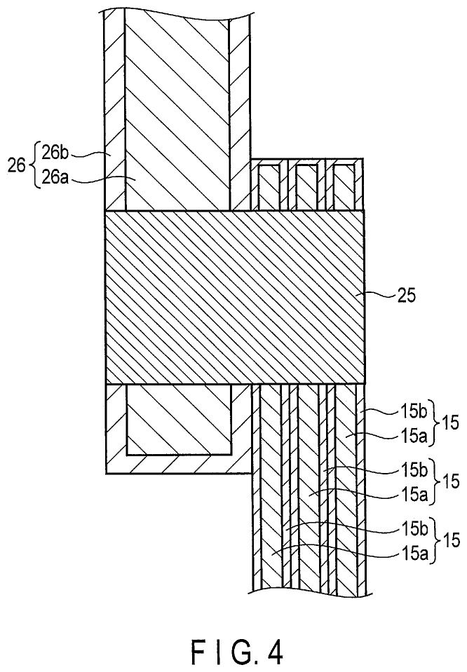

FIG. 4 is an enlarged schematic cross-sectional view showing the vicinity of the joint 25. For the sake of simplicity, FIG. 4 shows a case where three negative electrode tabs 15 are stacked such that their main surfaces face each other, but the number of negative electrode tabs 15 may be at least one. The number of negative electrode tabs 15 may be 4 or more. The negative electrode lead 26 includes a negative electrode lead main body 26a as a base material and a negative electrode lead coating 26b that covers the entire surface of the negative electrode lead main body 26a. The negative electrode lead coating 26b covers not only the main surface of the negative electrode lead main body 26a but also the side surface (end surface) of the negative electrode lead main body 26a. Each of the negative electrode current collectors 15 includes a negative electrode current collector main body 15a and a negative electrode current collector coating 15b that covers the entire surface of the negative electrode current collector main body 15a. The negative electrode current collector coating 15b covers not only the main surface of the negative electrode current collector main body 15a but also the side surface (end face) of the negative electrode current collector main body 15a. The negative electrode lead coating 26b is thicker than the negative electrode current collector coating 15b included in the single negative electrode current collector 15.

Although not shown, the vicinity of the positive electrode joint 27 has a similar structure. For example, three positive electrode tabs 14 are stacked such that their main surfaces face each other. The number of positive electrode tabs 14 is at least one. The positive electrode lead 22 includes a positive electrode lead main body as a base material and a positive electrode lead coating that covers the entire surface of the positive electrode lead main body. The positive electrode lead coating covers not only the main surface of the positive electrode lead body but also the side surface (end face) of the positive electrode lead body. Each of the positive electrode current collectors includes a positive electrode current collector main body and a positive electrode current collector coating that covers the entire surface of the positive electrode current collector main body. The positive electrode current collector coating covers not only the main surface of the positive electrode current collector main body but also the side surface (end surface) of the positive electrode current collector main body. The positive electrode lead coating is thicker than the positive electrode current collector coating provided in the single positive electrode current collector.

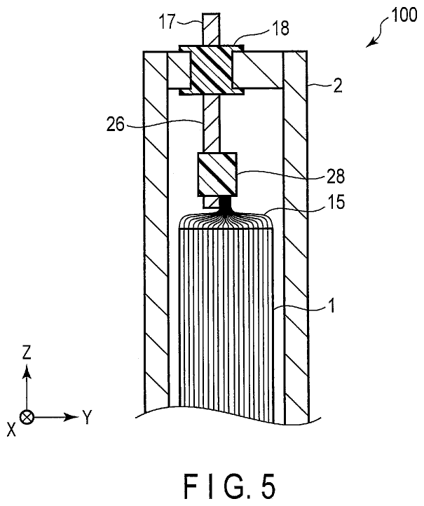

The secondary battery 100 shown in FIG. 5 has the same structure as the secondary battery described above with reference to FIGS. 1 to 4, except that the entire surface of the negative electrode joint 25 shown in FIG. 3 and its vicinity are covered with a water-repellent member 28. In the negative electrode joint 25, the base material of the current collector or the lead member may be exposed. However, when the entire surface of the negative electrode joint 25 is covered with the water-repellent member 28, it is possible to prevent such a base material from being exposed to the aqueous electrolyte.

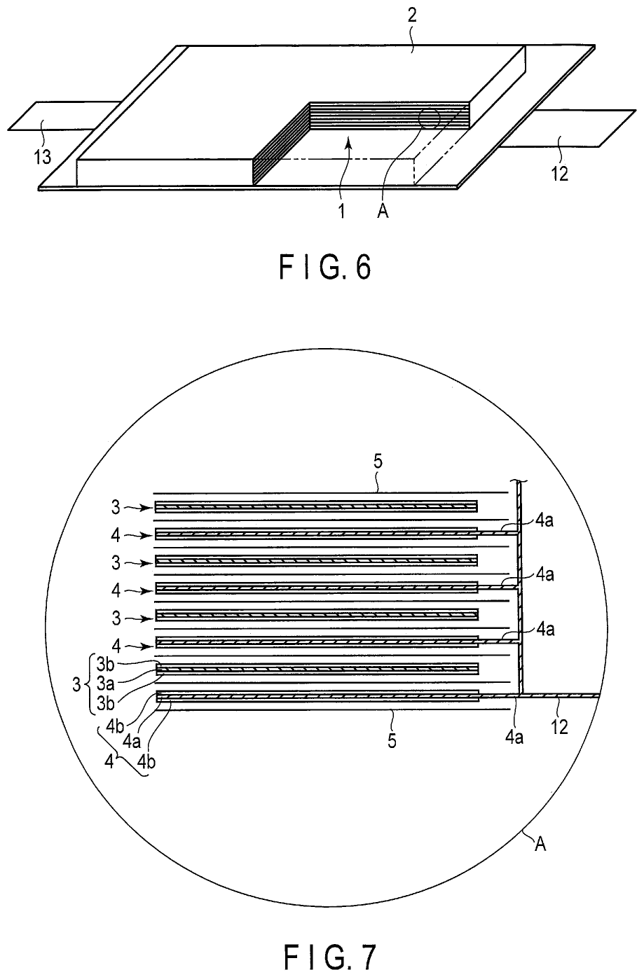

FIGS. 6 and 7 show an example of a secondary battery using a metal container made of a stacked film.

A stacked electrode group 1 is housed in a bag-shaped container 2 having a stacked film including a metal layer interposed between two resin films. An aqueous electrolyte is held in the electrode group 1, for example. As shown in FIG. 7, the stacked electrode group 1 has a structure in which a positive electrode 3 and a negative electrode 4 are alternately stacked with a separator 5 interposed therebetween. A plurality of positive electrodes 3 are present and each include a current collector 3a and positive electrode active material-containing layers 3b formed on both surfaces of the current collector 3a. A plurality of negative electrodes 4 are present and each include a current collector 4a and negative electrode active material-containing layers 4b formed on both surfaces of the current collector 4a. One side of the current collector 4a of each negative electrode 4 protrudes from each positive electrode 3. The protruding current collector 4a is electrically connected to a strip-shaped negative electrode terminal 12. The tip of the strip-shaped negative electrode terminal 12 is pulled out from a container 2. Further, although not shown, the current collector 3a of each positive electrode 3 has a side located on the opposite side to the protruding side of the current collector 4a and protruding from the negative electrode 4. The current collector 3a protruding from the negative electrode 4 is electrically connected to a strip-shaped positive electrode terminal 13. The tip of the strip-shaped positive electrode terminal 13 is located on the opposite side of the negative electrode terminal 12 and pulled out from the side of the container 2. Separators 5 are located on both outermost layers of the electrode group 1. The separator 5 of one of the outermost layers faces the positive electrode 3, and the separator 5 of the other outermost layer faces the negative electrode 4.

Each of the secondary batteries shown in FIGS. 1 to 7 can be provided with a safety valve for extracting hydrogen gas generated in the container to the outside. The safety valve can be used as either a return type that operates when the internal pressure rises above a set value and functions as a sealing plug when the internal pressure drops, or a non-returning type that does not recover a function as a sealing plug once it operates. Further, although the secondary batteries shown in FIGS. 1 to 7 are of a closed type, they can be an open system when they provided with a circulation system for returning hydrogen gas to water.

According to the first embodiment, a secondary battery is provided. The secondary battery includes a first electrode having a first current collector, a second electrode having a second current collector, and an aqueous electrolyte. The first electrode includes a first lead, and a first joint for electrically connecting the first current collector and the first lead. The second electrode includes a second lead, and a second joint for electrically connecting the second current collector and the second lead. The first electrode is one of a positive electrode and a negative electrode, and the second electrode is the other of the positive electrode and the negative electrode. At least a part of the surface of the first current collector has a first current collector coating. At least a part of the surface of the first lead has a first lead coating. Each of the first current collector and the first lead contains at least one selected from the group consisting of aluminum, aluminum alloys, copper, and nickel. Each of the first lead coating and the first current collector coating contains at least one selected from the group consisting of aluminum oxide, aluminum oxyhydroxide, chromium-containing compounds, and zinc-containing compounds. At least a part of the surface of the second current collector has a second current collector coating. At least a part of the surface of the second lead has a second lead coating. Each of the second current collector and the second lead contains at least one selected from the group consisting of aluminum, aluminum alloys, copper, and nickel. Each of the second lead coating and the second current collector coating contains at least one selected from the group consisting of aluminum oxide, aluminum oxyhydroxide, chromium-containing compounds, and zinc-containing compounds. The thickness of the first lead coating is larger than the thickness of the first current collector coating.

Therefore, since the electrolysis of water in the vicinity of the first joint can be suppressed, excellent charge/discharge efficiency can be maintained even after the charge/discharge cycle is repeated a plurality of times.

### Second Embodiment

According to a second embodiment, a battery module is provided. The battery module according to the second embodiment includes a plurality of secondary batteries according to the first embodiment.

In the battery module according to the second embodiment, each of the single batteries may be arranged electrically connected in series, in parallel, or in a combination of in-series connection and in-parallel connection.

An example of the battery module according to the second embodiment will be described next with reference to the drawings.

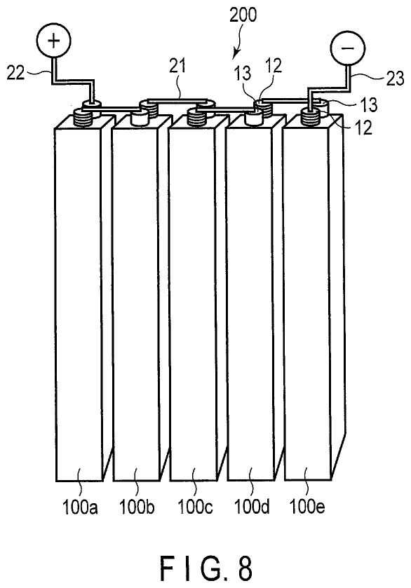

FIG. 8 is a perspective view schematically showing an example of the battery module according to the second embodiment. A battery module 200 shown in FIG. 8 includes five single-batteries 100a to 100e, four bus bars 21, a positive electrode-side lead 22, and a negative electrode-side lead 23. Each of the five single-batteries 100a to 100e is a secondary battery according to the first embodiment.

The bus bars 21 connects a negative electrode terminal 12 of a single unit cell 100a to a positive electrode terminal 13 of an adjacently positioned unit cell 100b. In this way, the five unit cells 100a to 100e are connected in series by the four bus bars 21. That is, the battery module 200 shown in FIG. 8 is a battery module of five in-series connection. Although an example is not illustrated, in a battery module containing a plurality of unit cells electrically connected in parallel, the plurality of unit cells may be electrically connected by connecting the plurality of negative electrode terminals to each other with busbars and also connecting the plurality of positive electrode terminals to each other with busbars, for example.

The positive electrode terminal 13 of at least one battery among the five unit cells 100a to 100e is electrically connected to a positive electrode lead 22 for external connection. Also, the negative electrode terminal 12 of at least one battery among the five unit cells 100a to 100e is electrically connected to a negative electrode lead 23 for external connection.

An battery module according to the second embodiment includes the secondary battery according to the first embodiment. Therefore, the battery module exhibits excellent charge/discharge efficiency.

### Third Embodiment

According to the third embodiment, a battery pack is provided. The battery pack includes the battery module according to the second embodiment. The battery pack may also be equipped with a single secondary battery according to the first embodiment instead of the battery module according to the second embodiment.

The battery pack according to the third embodiment may further include a protective circuit. The protective circuit has a function to control charging and discharging of the secondary battery. Alternatively, a circuit included in equipment where the battery pack serves as a power source (for example, electronic devices, vehicles, and the like) may be used as the protective circuit for the battery pack.

Moreover, the battery pack according to the third embodiment may further include an external power distribution terminal. The external power distribution terminal is configured to externally output current from the secondary battery, and to input external current into the secondary battery. In other words, when the battery pack is used as a power source, the current is provided out via the external power distribution terminal. When the battery pack is charged, the charging current (including regenerative energy of a motive force of vehicles such as automobiles) is provided to the battery pack via the external power distribution terminal.

Next, an example of a battery pack according to the third embodiment will be described with reference to the drawings.

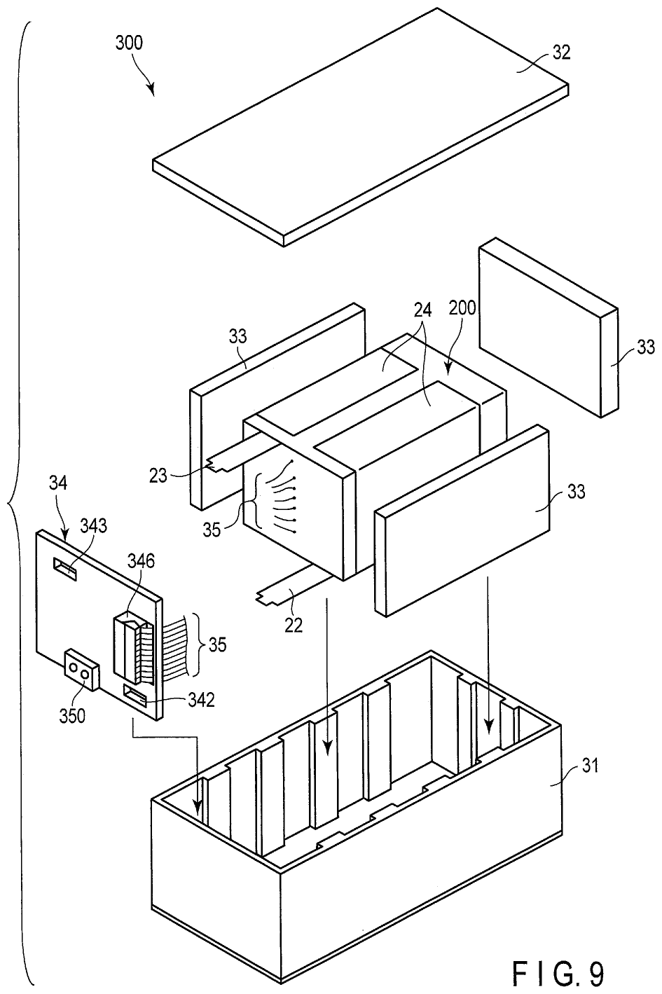

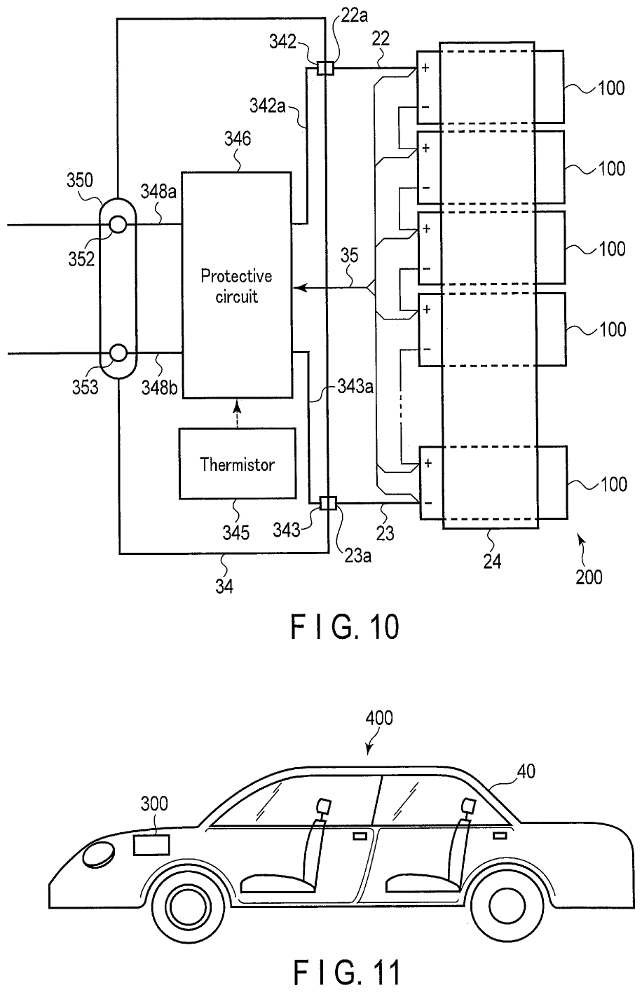

FIG. 9 is an exploded perspective view schematically showing an example of the battery pack according to the third embodiment. FIG. 10 is a block diagram showing an example of an electric circuit of the battery pack shown in FIG. 9.

A battery pack 300 shown in FIGS. 9 and 10 includes a housing container 31, a lid 32, protective sheets 33, a battery module 200, a printed wiring board 34, wires 35, and an insulating plate (not shown).

A housing container 31 shown in FIG. 9 is a bottomed-square-shaped container having a rectangular bottom surface. The housing container 31 is configured to house protective sheet 33, a battery module 200, a printed wiring board 34, and wires 35. A lid 32 has a rectangular shape. The lid 32 covers the housing container 31 to house the battery module 200 and the like. Although not shown, opening(s) or connection terminal(s) for connecting to external device(s) and the like are provided on the housing container 31 and lid 32.

The battery module 200 includes plural unit cells 100, a positive electrode-side lead 22, a negative electrode-side lead 23, and an adhesive tape 24.

At least one in the plurality of unit cells 100 is a secondary battery according to the first embodiment. Each unit cell 100 in the plurality of unit cells 100 is electrically connected in series, as shown in FIG. 10. The plurality of unit cells 100 may alternatively be electrically connected in parallel, or connected in a combination of in-series connection and in-parallel connection. If the plurality of unit cells 100 is connected in parallel, the battery capacity increases as compared to a case where they are connected in series.

The adhesive tape 24 fastens the plural unit cells 100. The plural unit cells 100 may be fixed using a heat-shrinkable tape in place of the adhesive tape 24. In this case, the protective sheets 33 are arranged on both side surfaces of the battery module 200, and the heat-shrinkable tape is wound around the battery module 200 and protective sheets 33. After that, the heat-shrinkable tape is shrunk by heating to bundle the plural unit cells 100.

One terminal of a positive electrode lead 22 is connected to a battery module 200. One terminal of the positive electrode lead 22 is electrically connected to the positive electrode of one or more unit cells 100. One terminal of a negative electrode lead 23 is connected to the battery module 200. One terminal of the negative electrode lead 23 is electrically connected to the negative electrode of one or more unit cells 100.

The printed wiring board 34 is arranged on the inner surface of the housing container 31 along the short side direction. The printed wiring board 34 includes a positive electrode connector 342, a negative electrode connector 343, a thermistor 345, a protective circuit 346, wirings 342a and 343a, an external power distribution terminal 350, a plus-side wire (positive-side wire) 348a, and a minus-side wire (negative-side wire) 348b. One principal surface of the printed wiring board 34 faces one side surface of the battery module 200. An insulating plate (not shown) is disposed in between the printed wiring board 34 and the battery module 200.

The other terminal 22a of the positive electrode lead 22 is electrically connected to a positive electrode connector 342. The other terminal 23a of the negative electrode lead 23 is electrically connected to a negative electrode connector 343.

The thermistor 345 is fixed to one principal surface of the printed wiring board 34. The thermistor 345 detects the temperature of each unit cell 100 and transmits detection signals to the protective circuit 346.

The external power distribution terminal 350 is fixed to the other principal surface of the printed wiring board 34. The external power distribution terminal 350 is electrically connected to device(s) that exists outside the battery pack 300. The external power distribution terminal 350 includes a positive side terminal 352 and a negative side terminal 353.

The protective circuit 346 is fixed to the other principal surface of the printed wiring board 34. The protective circuit 346 is connected to the positive side terminal 352 via the plus-side wire 348a. The protective circuit 346 is connected to the negative side terminal 353 via the minus-side wire 348b. In addition, the protective circuit 346 is electrically connected to the positive electrode connector 342 via the wiring 342a. The protective circuit 346 is electrically connected to the negative electrode connector 343 via the wiring 343a. Furthermore, the protective circuit 346 is electrically connected to each unit cell 100 in the plurality of unit cells 100 via the wires 35.

The protective sheets 33 are arranged on both inner surfaces of the housing container 31 along the long side direction and on one inner surface of the housing container 31 along the short side direction facing the printed wiring board 34 through the battery module 200. The protective sheet 33 is made of, for example, resin or rubber.

The protective circuit 346 controls charging and discharging of the plurality of unit cells 100. The protective circuit 346 is also configured to cut off electric connection between the protective circuit 346 and the external power distribution terminal 350 (the positive side terminal 352 and the negative side terminal 353) to the external devices, based on detection signals transmitted from the thermistor 345 or detection signals transmitted from each unit cell 100 or the battery module 200.

An example of the detection signal transmitted from the thermistor 345 is a signal indicating that the temperature of the unit cell(s) 100 is detected to be a predetermined temperature or more. An example of the detection signal transmitted from each unit cell 100 or the battery module 200 is a signal indicating detection of over-charge, over-discharge, and overcurrent of the unit cell(s) 100. When detecting over-charge or the like for each of the unit cells 100, the battery voltage may be detected, or a positive electrode potential or negative electrode potential may be detected. In the latter case, a lithium electrode to be used as a reference electrode may be inserted into each unit cell 100.

Note, that as the protective circuit 346, a circuit included in a device (for example, an electronic device or an automobile) that uses the battery pack 300 as a power source may be used.

As described above, the battery pack 300 includes the external power distribution terminal 350. Hence, the battery pack 300 can output current from the battery module 200 to an external device and input current from an external device to the battery module 200 via the external power distribution terminal 350. In other words, when using the battery pack 300 as a power source, the current from the battery module 200 is supplied to an external device via the external power distribution terminal 350. When charging the battery pack 300, a charge current from an external device is supplied to the battery pack 300 via the external power distribution terminal 350. If the battery pack 300 is used as an onboard battery, the regenerative energy of the motive force of a vehicle can be used as the charge current from the external device.

Note that the battery pack 300 may include a plurality of battery modules 200. In this case, the plurality of battery modules 200 may be connected in series, in parallel, or connected in a combination of in-series connection and in-parallel connection. The printed wiring board 34 and the wires 35 may be omitted. In this case, the positive electrode lead 22 and the negative electrode lead 23 may be used as the positive side terminal and the negative side terminal of the external power distribution terminal, respectively.

Such a battery pack is used for, for example, an application required to have the excellent cycle performance when a large current is taken out. More specifically, the battery pack is used as, for example, a power source for electronic devices, a stationary battery, or an onboard battery for various kinds of vehicles. An example of the electronic device is a digital camera. The battery pack is particularly favorably used as an onboard battery.

A battery pack according to the third embodiment includes the secondary battery according to the first embodiment or the battery module according to the second embodiment. Therefore, this battery pack exhibits excellent charge/discharge efficiency.

### Fourth Embodiment

According to the fourth embodiment, a vehicle is provided. The vehicle includes the battery pack according to the third embodiment.

In a vehicle according to the fourth embodiment, the battery pack is configured, for example, to recover regenerative energy from motive force of the vehicle. The vehicle may include a mechanism configured to convert kinetic energy of the vehicle into regenerative energy.

Examples of the vehicle include two- to four-wheeled hybrid electric automobiles, two- to four-wheeled electric automobiles, electric assist bicycles, and railway cars. A vehicle may be equipped with a plurality of battery packs. In this case, the battery packs may be electrically connected in series, may be electrically connected in parallel, or may be electrically connected in series and in parallel.

Next, an example of the vehicle according to the fourth embodiment will be described with reference to the drawings.

FIG. 11 is a cross-sectional view schematically showing an example of the vehicle according to the fourth embodiment.

The vehicle 400 shown in FIG. 11 includes a vehicle body 40 and the battery pack 300 according to the third embodiment. In the example shown in FIG. 11, the vehicle 400 is a four-wheeled vehicle.

The vehicle 400 may be equipped with a plurality of battery packs 300. In this case, the battery packs 300 may be connected in series, may be connected in parallel, or may be connected in series and in parallel.

In FIG. 11, the battery pack 300 is installed in an engine compartment located at the front of the vehicle body 40. As described above, the battery pack 300 may be installed in rear sections of the vehicle body 40, or under a seat. The battery pack 300 may be used as a power source of the vehicle 400. In addition, the battery pack 300 can recover regenerative energy of a motive force of the vehicle 400.

The vehicle according to the fourth embodiment is equipped with the battery pack according to the third embodiment. Therefore, according to the present embodiment, it is possible to provide a vehicle provided with a battery pack having excellent charge/discharge efficiency.

### Fifth Embodiment

According to the fifth embodiment, a stationary power supply is provided. The stationary power supply is mounted with the battery pack according to the third embodiment. Note that instead of the battery pack according to the third embodiment, the stationary power supply may have the secondary battery according to the first embodiment or the battery module according to the second embodiment.

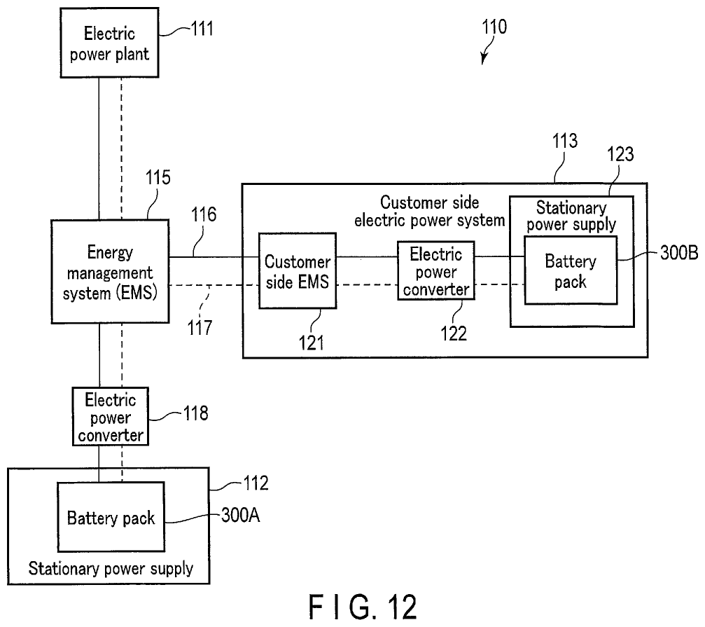

FIG. 12 is a block diagram showing an example of a system including a stationary power supply according to the fifth embodiment. FIG. 12 is a diagram showing an application example to stationary power supplies 112, 123 as an example of use of battery packs 300A, 300B according to the third embodiment. In the example shown in FIG. 12, a system 110 in which the stationary power supplies 112, 123 are used is shown. The system 110 includes an electric power plant ill, the stationary power supply 112, a customer side electric power system 113, and an energy management system (EMS) 115. Also, an electric power network 116 and a communication network 117 are formed in the system 110, and the electric power plant 111, the stationary power supply 112, the customer side electric power system 113 and the EMS 115 are connected via the electric power network 116 and the communication network 117. The EMS 115 performs control to stabilize the entire system 110 by utilizing the electric power network 116 and the communication network 117.

The electric power plant 111 generates a large amount of electric power from fuel sources such as thermal power or nuclear power. Electric power is supplied from the electric power plant ill through the electric power network 116 and the like. In addition, the battery pack 300A is installed in the stationary power supply 112. The battery pack 300A can store electric power and the like supplied from the electric power plant 111. In addition, the stationary power supply 112 can supply the electric power stored in the battery pack 300A through the electric power network 116 and the like. The system 110 is provided with an electric power converter 118. The electric power converter 118 includes a converter, an inverter, a transformer and the like. Thus, the electric power converter 118 can perform conversion between direct current (DC) and alternate current (AC), conversion between alternate currents of frequencies different from each other, voltage transformation (step-up and step-down) and the like. Therefore, the electric power converter 118 can convert electric power from the electric power plant 111 into electric power that can be stored in the battery pack 300A.

The customer side electric power system 113 includes an electric power system for factories, an electric power system for buildings, an electric power system for home use and the like. The customer side electric power system 113 includes a customer side EMS 121, an electric power converter 122, and the stationary power supply 123. The battery pack 300B is installed in the stationary power supply 123. The customer side EMS 121 performs control to stabilize the customer side electric power system 113.

Electric power from the electric power plant 111 and electric power from the battery pack 300A are supplied to the customer side electric power system 113 through the electric power network 116. The battery pack 300B can store electric power supplied to the customer side electric power system 113. Similarly to the electric power converter 118, the electric power converter 122 includes a converter, an inverter, a transformer and the like. Thus, the electric power converter 122 can perform conversion between direct current and alternate current, conversion between alternate currents of frequencies different from each other, voltage transformation (step-up and step-down) and the like. Therefore, the electric power converter 122 can convert electric power supplied to the customer side electric power system 113 into electric power that can be stored in the battery pack 300B.

Note that the electric power stored in the battery pack 300B can be used, for example, for charging a vehicle such as an electric vehicle. Also, the system 110 may be provided with a natural energy source. In such a case, the natural energy source generates electric power by natural energy such as wind power and solar light. In addition to the electric power plant 111, electric power is also supplied from the natural energy source through the electric power network 116.

A stationary power supply according to the fifth embodiment includes the battery pack according to the third embodiment. Therefore, according to the present embodiment, it is possible to provide a stationary power supply provided with a battery pack having excellent charge/discharge efficiency.

### EXAMPLES

Examples will be described below, but the embodiments are not limited to the examples described below.

### Example 1

A secondary battery was produced as described below.

(Production of Negative Electrode)

Lithium titanate Li₄Ti₅O₁₂ was used as the negative electrode active material, acetylene black was used as an electro-conductive agent, and PTFE was used as a binder. The composition ratio of the negative electrode active material, the electro-conductive agent, and the binder in a negative electrode active material-containing layer was set to 100:20:10 in terms of weight ratio. Each powder was put into an N-methyl-2-pyrrolidone (NMP) solvent, mixed, and stirred to prepare a slurry for preparing the negative electrode active material-containing layer. As a current collector, a strip-shaped aluminum foil with a thickness of 20 μm was prepared. The entire surface of this current collector was anodized to form an aluminum oxide coating. In the anodizing treatment, the aluminum foil was immersed in a 15 wt % sulfuric acid aqueous solution, and a current with a current density of 10 mA/cm² was applied at room temperature for 30 seconds.

The slurry prepared above was applied on both surfaces of the strip-shaped current collector having the aluminum oxide coating, and the solvent was dried to prepare the negative electrode active material-containing layer. At this time, an uncoated portion to which the slurry was not applied was provided at the end on the long side of the strip-shaped current collector. This uncoated portion functions as a current collecting tab. The electrode basis weight was 20 g/m². Then, the current collector was cut using a slitter such that the current collecting tab protruded from one side of the long side of the strip-shaped current collector. In this way, a negative electrode in which negative electrode active material-containing layers were stacked on both surfaces of the negative electrode current collector was produced.

A plurality of negative electrodes obtained by the above method were produced.

(Production of Negative Electrode Lead Member)

As the negative electrode lead member, an aluminum foil having a strip shape and a thickness of 200 μm was prepared. The entire surface of the lead member was anodized to form an aluminum oxide coating. As for the conditions of the anodizing treatment, in the anodizing treatment, the aluminum foil was immersed in a 15 wt % sulfuric acid aqueous solution, and a current having a current density of 10 mA/cm² was applied for 300 seconds at room temperature.

(Production of Positive Electrode)

Lithium manganate LiMn₂O₄ was used as the positive electrode active material, acetylene black was used as an electro-conductive agent, and PVdF was used as a binder. The composition ratio of the positive electrode active material, the electro-conductive agent, and the binder in a positive electrode active material-containing layer was set to 100:10:10 in terms of weight ratio. Each powder was put into an N-methyl-2-pyrrolidone solution, mixed, and stirred to prepare a slurry for preparing the positive electrode active material-containing layer. As a current collector, a strip-shaped aluminum foil with a thickness of 20 μm was prepared. The entire surface of this current collector was anodized to form an aluminum oxide coating. In the anodizing treatment, the aluminum foil was immersed in a 15 wt % sulfuric acid aqueous solution, and a current with a current density of 10 mA/cm² was applied at room temperature for 30 seconds.

The slurry prepared above was applied onto both surfaces of the strip-shaped current collector having the aluminum oxide coating, and the solvent was dried to prepare the positive electrode active material-containing layer. At this time, an uncoated portion to which the slurry was not applied was provided at the end on the long side of the strip-shaped current collector. This uncoated portion functions as a current collecting tab. The electrode basis weight was adjusted such that the capacity ratio of the positive electrode to the negative electrode was 1.5 times. Then, the current collector was cut using a slitter such that the current collecting tab protruded from one side of the long side of the strip-shaped current collector. In this way, a positive electrode in which positive electrode active material-containing layers were stacked on both surfaces of the positive electrode current collector was produced.

A plurality of positive electrodes obtained by the above method were produced.

(Production of Positive Electrode Lead Member)

As the positive electrode lead member, an aluminum foil having a strip shape and a thickness of 200 μm was prepared. The entire surface of the lead member was anodized to form an aluminum oxide coating. In the anodizing treatment, the aluminum foil was immersed in a 15 wt % sulfuric acid aqueous solution, and a current with a current density of 10 mA/cm² was applied for 300 seconds at room temperature.

(Production of Separator)

An LATP solid electrolyte membrane, which is a mixture of Li_{1.3}Al_{0.3}Ti_{1.7}(PO₄)₃ (hereinafter abbreviated as LATP) and polyvinyl butyral as a polymer material, was formed on a cellulose sheet to form, as the separator, a composite membrane of the LATP solid electrolyte membrane and the cellulose sheet. A plurality of such separators were produced.

(Production of Electrode Group, Welding of Current Collector and Lead Member, and Storage in Container Member)

A stacked electrode group was produced by alternately stacking a plurality of negative electrodes, a plurality of positive electrodes, and a plurality of separators such that a separator was interposed between a negative electrode and a positive electrode. After that, each negative electrode current-collecting tab provided in the plurality of negative electrodes was bundled and joined to one end of the negative electrode lead member. This joining was performed by ultrasonic welding. This joint is called a negative electrode joint. Separately, a lid of a container member provided with a positive electrode terminal and a negative electrode terminal was prepared. The other end of the negative electrode lead member was electrically connected to the negative electrode terminal.

In addition, each positive electrode current-collecting tab provided in a plurality of positive electrodes was bundled and joined to one end of the positive electrode lead member. This joining was performed by ultrasonic welding. This joint is called a positive electrode joint. The other end of the positive electrode lead member was electrically connected to the positive electrode terminal. In this way, an electrode group-lead joint body was formed.

The electrode group-lead joint body was housed in an aluminum stacked container member, and an aqueous electrolyte was injected. As the aqueous electrolyte, an aqueous solution in which a trace amount of zinc metal was dissolved in an aqueous solution containing a LiCl salt at a concentration of 12 M was used. The concentration of zinc ions in the aqueous solution was 1.6 mg/L. A gap between the aluminum stacked container member and the positive and negative electrode leads was bonded by heat fusion to produce a secondary battery.

### Examples 2 to 5

As shown in Tables 1 to 4, a secondary battery was produced by the method shown in Example 1, except that the thicknesses of the current collectors of the positive and negative electrodes and the thicknesses of the positive and negative electrode leads are changed, and the thicknesses of the current collector coatings of the positive and negative electrodes and the thicknesses of the positive and negative electrode lead coatings are changed under the treatment conditions changed.

### Example 6

A secondary battery was produced in the same manner as in Example 1 except for the contents described below.

At the time of the production of the current collector coatings of the positive and negative electrodes, boehmite treatment was performed on the entire surface of each current collector to form an aluminum oxyhydroxide coating. In the boehmite treatment, the current collectors were immersed in a 0.15 wt % aqueous ammonia solution, and high-temperature treatment was performed at a solution temperature of 90° C. for 10 minutes.

Further, at the time of the production of the lead members of the positive and negative electrodes, boehmite treatment was performed on the entire surface of each lead member to form an aluminum oxyhydroxide coating. In the boehmite treatment, the current collectors were immersed in a 0.15 wt % aqueous ammonia solution, and high-temperature treatment was performed at a solution temperature of 90° C. for 50 minutes.

### Example 7

A secondary battery was produced in the same manner as in Example 1 except for the contents described below.

At the time of the production of the current collector coatings of the positive and negative electrodes, chromate treatment was performed on the entire surface of each current collector to form a coating containing a chromium-containing compound. In the chromate treatment, as a chromium substitution step, the lead members were immersed in an aqueous solution containing 0.1 wt % chromic anhydride, 0.1 wt % sulfuric acid, and 0.1 wt % nitric acid at room temperature for 30 seconds. Then, the lead members were washed with water and dried.

Further, at the time of the production of the lead members of the positive and negative electrodes, chromate treatment was performed on the entire surface of each lead member to form a coating containing a chromium-containing compound. In the chromate treatment, as a chromium substitution step, the lead members were immersed in an aqueous solution containing 0.1 wt % chromic anhydride, 0.1 wt % sulfuric acid, and 0.1 wt % nitric acid at room temperature for 300 seconds. Then, the lead members were washed with water and dried.

### Example 8

A secondary battery was produced in the same manner as in Example 1 except for the contents described below.

At the time of the production of the current collector coatings of the positive and negative electrodes, zincate treatment was performed on the entire surface of each current collector to form a coating containing a zinc-containing compound. In the zincate treatment, an aqueous solution containing zinc oxide at a concentration of 100 g/L and sodium hydroxide at a concentration of 300 g/L was used as the zinc substitution step. At room temperature, the current collectors were kept immersed in this aqueous solution for 60 seconds. Then, after washing with water, the current collectors were immersed in a nitric acid solution for another 30 seconds. Then, the above zinc substitution step was performed again to prepare a coating containing a zinc-containing compound on the surfaces of the current collectors.

Further, at the time of the production of the lead members of the positive and negative electrodes, zincate treatment was performed on the entire surface of each lead member to form a coating containing a zinc-containing compound. As for the conditions of the zincate treatment, in the zincate treatment, an aqueous solution containing zinc oxide at a concentration of 100 g/L and sodium hydroxide at a concentration of 300 g/L was used as the zinc substitution step. At room temperature, the current collectors were kept immersed in this aqueous solution for 600 seconds. Then, after washing with water, the current collectors were immersed in a nitric acid solution for another 30 seconds. Then, the above zinc substitution step was performed again to prepare a coating containing a zinc-containing compound on the surfaces of the current collectors.

### Example 9

As shown in Tables 1 to 4, a secondary battery was produced by the method shown in Example 1, except that the thicknesses of the current collectors of the positive and negative electrodes and the thicknesses of the positive and negative electrode leads are changed, and the thicknesses of the current collector coatings of the positive and negative electrodes and the thicknesses of the positive and negative electrode lead coatings are changed under the treatment conditions changed.

In Example 9, the thickness of the negative electrode current collector coating and the thickness of the negative electrode lead coating were the same.

### Example 10

As shown in Tables 1 to 4, a secondary battery was produced by the method shown in Example 1, except that the thicknesses of the current collectors of the positive and negative electrodes and the thicknesses of the positive and negative electrode leads are changed, and the thicknesses of the current collector coatings of the positive and negative electrodes and the thicknesses of the positive and negative electrode lead coatings are changed under the treatment conditions changed.

In Example 10, the thickness of the positive electrode current collector coating and the thickness of the positive electrode lead coating were the same.

### Example 11

A secondary battery was produced in the same manner as in Example 1 except for the contents described below.

A copper foil having a thickness of 20 μm was used as the negative electrode current collector, and the zincate treatment was performed on the entire surface of the copper foil under the conditions shown in Table 3. Moreover, a copper foil having a thickness of 0.2 mm was used as the negative electrode lead, and the zincate treatment was performed on the entire surface of the copper foil under the conditions shown in Table 4.

### Example 12

A secondary battery was produced in the same manner as in Example 1 except for the contents described below.

A nickel foil having a thickness of 50 μm was used as the negative electrode current collector, and the zincate treatment was performed on the entire surface of the nickel foil under the conditions shown in Table 3. In addition, a nickel foil with a thickness of 0.2 mm was used as the negative electrode lead, and the zincate treatment was performed on the entire surface of the nickel foil under the conditions shown in Table 4.

### Example 13

A secondary battery was produced under the same conditions as in Example 1, except that the positive electrode current collector produced under the same conditions as in Example 2 was used as the positive electrode current collector, and the positive electrode lead produced under the same conditions as in Example 6 was used as the positive electrode lead.

### Example 14

A secondary battery was produced under the same conditions as in Example 1, except that the positive electrode current collector produced under the same conditions as in Example 2 was used as the positive electrode current collector, and the positive electrode lead produced under the same conditions as in Example 7 was used as the positive electrode lead.

### Example 15

A secondary battery was produced under the same conditions as in Example 1, except that the positive electrode current collector produced under the same conditions as in Example 2 was used as the positive electrode current collector, and the positive electrode lead produced under the same conditions as in Example 8 was used as the positive electrode lead.

### Example 16

A secondary battery was produced under the same conditions as in Example 1, except that the negative electrode current collector produced under the same conditions as in Example 2 was used as the negative electrode current collector, and the negative electrode lead produced under the same conditions as in Example was used as the negative electrode lead.

### Example 17

A secondary battery was produced under the same conditions as in Example 1, except that the negative electrode current collector produced under the same conditions as in Example 2 was used as the negative electrode current collector, and the negative electrode lead produced under the same conditions as in Example 7 was used as the negative electrode lead.

### Example 18

A secondary battery was produced under the same conditions as in Example 1, except that the negative electrode current collector produced under the same conditions as in Example 2 was used as the negative electrode current collector, and the negative electrode lead produced under the same conditions as in Example 8 was used as the negative electrode lead.

### Example 19

A secondary battery was produced in the same manner as in Example 1, except that the entire positive electrode joint and the entire negative electrode joint were covered with a water-repellent member made of polypropylene.

### Comparative Example 1

As shown in Tables 1 to 4, a secondary battery was produced by the method shown in Example 1, except that the thicknesses of the current collectors of the positive and negative electrodes and the thicknesses of the positive and negative electrode leads are changed, and the thicknesses of the current collector coatings of the positive and negative electrodes and the thicknesses of the positive and negative electrode lead coatings are changed under the treatment conditions changed.

In Comparative Example 1, the thickness of the positive electrode lead coating was smaller than the thickness of the positive electrode current collector coating, and the thickness of the negative electrode lead coating was smaller than the thickness of the negative electrode current collector coating.

### Comparative Example 2

A secondary battery was produced in the same manner as in Example 2, except that the positive electrode current collector and the positive electrode lead were not anodized. That is, neither the positive electrode current collector nor the positive electrode lead according to Comparative Example 2 had a protective coating.

### Comparative Example 3

A secondary battery was produced in the same manner as in Example 2, except that the negative electrode current collector and the negative electrode lead were not anodized. That is, neither the negative electrode current collector nor the negative electrode lead according to Comparative Example 3 had a protective coating.

### Comparative Example 4

A secondary battery was produced in the same manner as in Example 2, except that the positive electrode current collector, the positive electrode lead, the negative electrode current collector, and the negative electrode lead were not anodized. That is, none of the positive electrode current collector, the positive electrode lead, the negative electrode current collector, and the negative electrode lead according to Comparative Example 4 had a protective coating.

### Comparative Example 5

A secondary battery was produced in the same manner as in Example 2, except that a titanium foil with a thickness of 20 μm and without a protective coating was used as the positive electrode current collector, and a titanium foil with a thickness of 0.5 mm and without a protective coating was used as the positive electrode lead.

### Comparative Example 6

A secondary battery was produced in the same manner as in Example 2, except that a zinc foil with a thickness of 50 μm and without a protective coating was used as the negative electrode current collector, and a zinc foil with a thickness of 0.5 mm and without a protective coating was used as the negative electrode lead.

### Comparative Example 7

A secondary battery was produced in the same manner as in Example 2, except that a tin foil with a thickness of 50 μm and without a protective coating was used as the negative electrode current collector, and a tin foil with a thickness of 0.5 mm and without a protective coating was used as the negative electrode lead.

<Constant Current Charge/Discharge Test>

For the secondary batteries produced in each Example, a test was started immediately after the batteries were produced without waiting time. Both charging and discharging were performed at a 0.5 C rate. The condition for ending the charging was that the current value reached 0.25 C, the charging time reached 130 minutes, or the charging capacity reached 170 mAh/g, whichever was the earliest. The condition for ending the discharging was that 130 minutes elapsed from the start of the discharging.

Performing the charging once and performing the discharging once were treated as one charge/discharge cycle, and the charge/discharge efficiency was calculated as a percentage from the charge capacity and the discharge capacity in the 20th cycle according to the following equation.

[The charge/discharge efficiency] (%)=100×[the discharge capacity]/[the charge capacity]

<Measurement of Thicknesses of Coatings>

For the secondary batteries produced in each Example, the composition of the positive electrode current collector coating, the positive electrode lead coating, the negative electrode current collector coating, and the negative electrode lead coating was confirmed according to the method described in the first embodiment. Moreover, the thicknesses of these coatings were measured.

The above results are shown in Tables 1 to 4 below. In Table 2, the column of “presence/absence of water-repellent member at joint” indicates whether or not the water-repellent member covering the joint between the positive electrode current collector and the positive electrode lead is provided. Further, in Table 4, the column of “presence/absence of water-repellent member at joint” indicates whether or not the water-repellent member covering the joint between the negative electrode current collector and the negative electrode lead is provided. In the column of zincate treatment shown in Tables 1 to 4, the time for performing the zinc substitution step once is displayed in seconds. For example, for the positive electrode current collector produced in Example 8, “60 (performed twice)”, which indicates that the zinc substitution step was performed for 60 seconds twice, is indicated. That is, it is shown that the positive electrode current collector according to Example 8 was subjected to the zinc substitution step for a total of 120 seconds. The same applies to the other examples.

TABLE 1

| | Positive electrode current collector | | | | | | |
|---|---|---|---|---|---|---|---|
| | | Thickness of | | Thickness | | | |
| | | current | | of | | | |
| | | collector | | coating | Treatment | | |
| | Material | (μm) | Composition of coating | (μm) | method | | |
| Example 1 | Aluminum | 20 | Aluminum oxide | 1 | Anodizing treatment | | |
| Example 2 | Aluminum | 30 | Aluminum oxide | 3 | Anodizing treatment | | |
| Example 3 | Aluminum | 30 | Aluminum oxide | 5 | Anodizing treatment | | |
| Example 4 | Aluminum | 50 | Aluminum oxide | 8 | Anodizing treatment | | |
| Example 5 | Aluminum | 50 | Aluminum oxide | 10 | Anodizing treatment | | |
| Example 6 | Aluminum | 50 | Aluminum oxyhydroxide | 3 | Boehmite treatment | | |
| Example 7 | Aluminum | 20 | Chromium containing compound | 3 | Chromate treatment | | |
| Example 8 | Aluminum | 20 | Zinc-containing compound | 3 | Zincate treatment | | |
| Example 9 | Aluminum | 30 | Aluminum oxide | 3 | Anodizing treatment | | |
| Example 10 | Aluminum | 30 | Aluminum oxide | 3 | Anodizing treatment | | |
| Example 11 | Aluminum | 30 | Aluminum oxide | 3 | Anodizing treatment | | |
| Example 12 | Aluminum | 30 | Aluminum oxide | 3' | Anodizing treatment | | |
| Example 13 | Aluminum | 30 | Aluminum oxide | 3 | Anodizing treatment | | |
| Example 14 | Aluminum | 30 | Aluminum oxide | 3 | Anodizing treatment | | |
| Example 15 | Aluminum | 30 | Aluminum oxide | 3 | Anodizing treatment | | |
| Example 16 | Aluminum | 30 | Aluminum oxide | 3 | Anodizing treatment | | |
| Example 17 | Aluminum | 30 | Aluminum oxide | 3 | Anodizing treatment | | |
| Example 18 | Aluminum | 30 | Aluminum oxide | 3 | Anodizing treatment | | |
| Example 19 | Aluminum | 20 | Aluminum oxide | 1 | Anodizing treatment | | |
| Comparative | Aluminum | 30 | Aluminum oxide | 3 | Anodizing treatment | | |
| example 1 | | | | | | | |
| Comparative | Aluminum | 30 | — | — | No treatment | | |
| example 2 | | | | | | | |
| Comparative | Aluminum | 30 | Aluminum oxide | 3 | Anodizing treatment | | |
| example 3 | | | | | | | |
| Comparative | Aluminum | 30 | — | — | No treatment | | |
| example 4 | | | | | | | |
| Comparative | Titanium | 20 | — | — | No treatment | | |
| example 5 | | | | | | | |
| Comparative | Aluminum | 30 | Aluminum oxide | 3 | Anodizing treatment | | |
| example 6 | | | | | | | |
| Comparative | Aluminum | 30 | Aluminum oxide | 3 | Anodizing treatment | | |
| example 7 | | | | | | | |
| | Positive electrode current collector | | | | | | |
| | Treatment conditions | | | | | | |
| | Anodizing treatment | | Boehmite treatment | | Chromate treatment | | Charge/ |
| | Current | Application | Solution | Treatment | Chromium | Zincate treatment | discharge |
| | density | time | temperature | time | substitution step | Zinc substitution step | efficiency |
| | (mA/cm²) | (seconds) | (° C.) | (minutes) | Time (seconds) | Time (seconds) | (%) |
| Example 1 | 10 | 30 | — | — | — | — | 90 |
| Example 2 | 10 | 90 | — | — | — | — | 91 |
| Example 3 | 10 | 150 | — | — | — | — | 93 |
| Example 4 | 10 | 240 | — | — | — | — | 95 |
| Example 5 | 10 | 300 | — | — | — | — | 96 |
| Example 6 | — | — | 90 | 10 | — | — | 92 |
| Example 7 | — | — | — | — | 30 | — | 93 |
| Example 8 | — | — | — | — | — | 60 (conducted twice) | 94 |
| Example 9 | 10 | 90 | — | — | — | — | 86 |
| Example 10 | 10 | 90 | — | — | — | — | 88 |
| Example 11 | 10 | 90 | — | — | — | — | 91 |
| Example 12 | 10 | 90 | — | — | — | — | 90 |
| Example 13 | 10 | 90 | — | — | — | — | 91 |
| Example 14 | 10 | 90 | — | — | — | — | 90 |
| Example 15 | 10 | 90 | — | — | — | — | 92 |
| Example 16 | 10 | 90 | — | — | — | — | 91 |
| Example 17 | 10 | 90 | — | — | — | — | 91 |
| Example 18 | 10 | 90 | — | — | — | — | 92 |
| Example 19 | 10 | 30 | — | — | — | — | 91 |
| Comparative | 10 | 90 | — | — | — | — | 79 |
| example 1 | | | | | | | |
| Comparative | — | — | — | — | — | — | 77 |
| example 2 | | | | | | | |
| Comparative | 10 | 90 | — | — | — | — | 74 |
| example 3 | | | | | | | |
| Comparative | — | — | — | — | — | — | 71 |
| example 4 | | | | | | | |
| Comparative | — | — | — | — | — | — | 81 |
| example 5 | | | | | | | |
| Comparative | 10 | 90 | — | — | — | — | 83 |
| example 6 | | | | | | | |
| Comparative | 10 | 90 | — | — | — | — | 82 |
| example 7 | | | | | | | |

TABLE 2

| | Positive electrode lead | | | | | | |
|---|---|---|---|---|---|---|---|
| | | Thickness | | Thickness | | | |
| | | of lead | | of coating | Treatment | | |
| | Material | (mm) | Composition of coating | (μm) | method | | |
| Example 1 | Aluminum | 0.2 | Aluminum oxide | 10 | Anodizing treatment | | |
| Example 2 | Aluminum | 0.2 | Aluminum oxide | 10 | Anodizing treatment | | |
| Example 3 | Aluminum | 0.2 | Aluminum oxide | 10 | Anodizing treatment | | |
| Example 4 | Aluminum | 0.5 | Aluminum oxide | 30 | Anodizing treatment | | |
| Example 5 | Aluminum | 0.5 | Aluminum oxide | 30 | Anodizing treatment | | |
| Example 6 | Aluminum | 0.5 | Aluminum oxyhydroxide | 10 | Boehmite treatment | | |
| Example 7 | Aluminum | 0.2 | Chromium-containing | 10 | Chromate treatment | | |
| | | | compound | | | | |
| Example 8 | Aluminum | 0.2 | Zinc-containing compound | 10 | Zincate treatment | | |
| Example 9 | Aluminum | 0.2 | Aluminum oxide | 10 | Anodizing treatment | | |
| Example 10 | Aluminum | 0.2 | Aluminum oxide | 3 | Anodizing treatment | | |
| Example 11 | Aluminum | 0.2 | Aluminum oxide | 10 | Anodizing treatment | | |
| Example 12 | Aluminum | 0.2 | Aluminum oxide | 10 | Anodizing treatment | | |
| Example 13 | Aluminum | 0.5 | Aluminum oxyhydroxide | 10 | Boehmite treatment | | |
| Example 14 | Aluminum | 0.2 | Chromium-containing | 10 | Chromate treatment | | |
| | | | compound | | | | |
| Example 15 | Aluminum | 0.2 | Zinc-containing compound | 10 | Zincate treatment | | |
| Example 16 | Aluminum | 0.2 | Aluminum oxide | 10 | Anodizing treatment | | |
| Example 17 | Aluminum | 0.2 | Aluminum oxide | 10 | Anodizing treatment | | |
| Example 18 | Aluminum | 0.2 | Aluminum oxide | 10 | Anodizing treatment | | |
| Example 19 | Aluminum | 0.2 | Aluminum oxide | 10 | Anodizing treatment | | |
| Comparative | Aluminum | 0.2 | Aluminum oxide | 2 | Anodizing treatment | | |
| example 1 | | | | | | | |
| Comparative | Aluminum | 0.2 | — | — | No treatment | | |
| example 2 | | | | | | | |
| Comparative | Aluminum | 0.2 | Aluminum oxide | 10 | Anodizing treatment | | |
| example 3 | | | | | | | |
| Comparative | Aluminum | 0.2 | — | — | No treatment | | |
| example 4 | | | | | | | |
| Comparative | Titanium | 0.5 | — | — | No treatment | | |
| example 5 | | | | | | | |
| Comparative | Aluminum | 0.2 | Aluminum oxide | 10 | Anodizing treatment | | |
| example 6 | | | | | | | |
| Comparative | Aluminum | 0.2 | Aluminum oxide | 10 | Anodizing treatment | | |
| example 7 | | | | | | | |
| | Positive electrode lead | | | | | | Presence/ |
| | Treatment conditions | | | | | | absence |
| | Anodizing treatment | | Boehmite treatment | | Chromate treatment | | of water- |
| | Current | Application | Solution | Treatment | Chromium | Zinc treatment | repellent |
| | density | time | temperature | time | substitution step | Zinc substitution step | number at |
| | (mA/cm²) | (seconds) | (° C.) | (minutes) | Time (seconds) | Time (seconds) | joint |
| Example 1 | 10 | 300 | — | — | — | — | Absence |
| Example 2 | 10 | 300 | — | — | — | — | Absence |
| Example 3 | 10 | 300 | — | — | — | — | Absence |
| Example 4 | 10 | 900 | — | — | — | — | Absence |
| Example 5 | 10 | 900 | — | — | — | — | Absence |
| Example 6 | — | — | 90 | 50 | — | — | Absence |
| Example 7 | — | — | — | — | 300 | — | Absence |
| Example 8 | — | — | — | — | — | 600 | Absence |
| | | | | | | (conducted twice) | |
| Example 9 | 10 | 300 | — | — | — | — | Absence |
| Example 10 | 10 | 90 | — | — | — | — | Absence |
| Example 11 | 10 | 300 | — | — | — | — | Absence |
| Example 12 | 10 | 300 | — | — | — | — | Absence |
| Example 13 | — | — | 90 | 50 | — | — | Absence |
| Example 14 | — | — | — | — | 300 | | Absence |
| Example 15 | — | — | — | — | — | 600 | Absence |
| | | | | | | (conducted twice) | |
| Example 16 | 10 | 300 | — | — | — | — | Absence |
| Example 17 | 10 | 300 | — | — | — | — | Absence |
| Example 18 | 10 | 300 | — | — | — | — | Absence |
| Example 19 | 10 | 300 | — | — | — | — | Presence |
| Comparative | 10 | 60 | — | — | — | — | Absence |
| example 1 | | | | | | | |
| Comparative | — | — | — | — | — | — | Absence |
| example 2 | | | | | | | |
| Comparative | 10 | 300 | — | — | — | — | Absence |
| example 3 | | | | | | | |
| Comparative | — | — | — | — | — | — | Absence |
| example 4 | | | | | | | |
| Comparative | — | — | — | — | — | — | Absence |
| example 5 | | | | | | | |
| Comparative | 10 | 300 | — | — | — | — | Absence |
| example 6 | | | | | | | |
| Comparative | 10 | 300 | — | — | — | — | Absence |
| example 7 | | | | | | | |

TABLE 3

| | Negative electrode current collector | | | | | |
|---|---|---|---|---|---|---|
| | | Thickness of | | Thickness | | |
| | | current | | of | | |
| | | collector | | coating | Treatment | |
| | Material | (μm) | Composition of coating | (μm) | method | |
| Example 1 | Aluminum | 20 | Aluminum oxide | 1 | Anodizing treatment | |
| Example 2 | Aluminum | 30 | Aluminum oxide | 3 | Anodizing treatment | |
| Example 3 | Aluminum | 30 | Aluminum oxide | 5 | Anodizing treatment | |
| Example 4 | Aluminum | 50 | Aluminum oxide | 8 | Anodizing treatment | |
| Example 5 | Aluminum | 50 | Aluminum oxide | 10 | Anodizing treatment | |
| Example 6 | Aluminum | 50 | Aluminum oxyhydroxide | 3 | Boehmite treatment | |
| Example 7 | Aluminum | 20 | Chromium containing compound | 3 | Chromate treatment | |
| Example 8 | Aluminum | 30 | Zinc-containing compound | 3 | Zincate treatment | |
| Example 9 | Aluminum | 30 | Aluminum oxide | 3 | Anodizing treatment | |
| Example 10 | Aluminum | 30 | Aluminum oxide | 3 | Anodizing treatment | |
| Example 11 | Copper | 20 | Zinc-containing compound | 3 | Zincate treatment | |
| Example 12 | Nickel | 50 | Zinc-containing compound | 3 | Zincate treatment | |
| Example 13 | Aluminum | 30 | Aluminum oxide | 3 | Anodizing treatment | |
| Example 14 | Aluminum | 30 | Aluminum oxide | 3 | Anodizing treatment | |
| Example 15 | Aluminum | 30 | Aluminum oxide | 3 | Anodizing treatment | |
| Example 16 | Aluminum | 30 | Aluminum oxide | 3 | Anodizing treatment | |
| Example 17 | Aluminum | 30 | Aluminum oxide | 3 | Anodizing treatment | |
| Example 18 | Aluminum | 30 | Aluminum oxide | 3 | Anodizing treatment | |
| Example 19 | Aluminum | 20 | Aluminum oxide | 1 | Anodizing treatment | |
| Comparative | Aluminum | 20 | Aluminum oxide | 3 | Anodizing treatment | |
| example 1 | | | | | | |
| Comparative | Aluminum | 30 | Aluminum oxide | 3 | Anodizing treatment | |
| example 2 | | | | | | |
| Comparative | Aluminum | 30 | — | — | No treatment | |
| example 3 | | | | | | |
| Comparative | Aluminum | 30 | — | — | No treatment | |
| example 4 | | | | | | |
| Comparative | Aluminum | 30 | Aluminum oxide | 3 | Anodizing treatment | |
| example 5 | | | | | | |
| Comparative | Zinc | 50 | — | — | No treatment | |
| example 6 | | | | | | |
| Comparative | Tin | 50 | — | — | No treatment | |
| example 7 | | | | | | |
| | Negative electrode current collector | | | | | |
| | Treatment conditions | | | | | |
| | Anodizing treatment | | Boehmite treatment | | Chromate treatment | |
| | Current | Application | Solution | Treatment | Chromium | Zincate treatment |
| | density | time | temperature | time | substitution step | Zinc substitution step |
| | (mA/cm²) | (seconds) | (° C.) | (minutes) | Time (seconds) | Time (seconds) |
| Example 1 | 10 | 30 | — | — | — | — |
| Example 2 | 10 | 90 | — | — | — | — |
| Example 3 | 10 | 150 | — | — | — | — |
| Example 4 | 10 | 240 | — | — | — | — |
| Example 5 | 10 | 300 | — | — | — | — |
| Example 6 | — | — | 90 | 10 | — | — |
| Example 7 | — | — | — | — | 30 | — |
| Example 8 | — | — | — | — | — | 60 (conducted twice) |
| Example 9 | 10 | 90 | — | — | — | — |
| Example 10 | 10 | 90 | — | — | — | — |
| Example 11 | — | — | — | — | — | 60 (conducted twice) |
| Example 12 | — | — | — | — | — | 60 (conducted twice) |
| Example 13 | 10 | 90 | — | — | — | — |
| Example 14 | 10 | 90 | — | — | — | — |
| Example 15 | 10 | 90 | — | — | — | — |
| Example 16 | 10 | 90 | — | — | — | — |
| Example 17 | 10 | 90 | — | — | — | — |
| Example 18 | 10 | 90 | — | — | — | — |
| Example 19 | 10 | 30 | — | — | — | — |
| Comparative | 10 | 90 | — | — | — | — |
| example 1 | | | | | | |
| Comparative | 10 | 90 | — | — | — | — |
| example 2 | | | | | | |
| Comparative | — | — | — | — | — | — |
| example 3 | | | | | | |
| Comparative | — | — | — | — | — | — |
| example 4 | | | | | | |
| Comparative | 10 | 90 | — | — | — | — |
| example 5 | | | | | | |
| Comparative | — | — | — | — | — | — |
| example 6 | | | | | | |
| Comparative | — | — | — | — | — | — |
| example 7 | | | | | | |

TABLE 4

| | Negative electrode lead | | | | | | |
|---|---|---|---|---|---|---|---|
| | | Thickness | | Thickness of | | | |
| | | of lead | Composition | coating | Treatment | | |
| | Material | (mm) | of coating | (μm) | method | | |
| Example 1 | Aluminum | 0.2 | Aluminum oxide | 10 | Anodizing treatment | | |
| Example 2 | Aluminum | 0.2 | Aluminum oxide | 10 | Anodizing treatment | | |
| Example 3 | Aluminum | 0.2 | Aluminum oxide | 10 | Anodizing treatment | | |
| Example 4 | Aluminum | 0.5 | Aluminum oxide | 30 | Anodizing treatment | | |
| Example 5 | Aluminum | 0.5 | Aluminum oxide | 30 | Anodizing treatment | | |
| Example 6 | Aluminum | 0.5 | Aluminum oxyhydroxide | 10 | Boehmite treatment | | |
| Example 7 | Aluminum | 0.2 | Chromium-containing | 10 | Chromate treatment | | |
| | | | compound | | | | |
| Example 8 | Aluminum | 0.2 | Zinc-containing compound | 10 | Zincate treatment | | |
| Example 9 | Aluminum | 0.2 | Aluminum oxide | 3 | Anodizing treatment | | |
| Example 10 | Aluminum | 0.2 | Aluminum oxide | 10 | Anodizing treatment | | |
| Example 11 | Copper | 0.2 | Zinc-containing compound | 10 | Zincate treatment | | |
| Example 12 | Nickel | 0.2 | Zinc-containing compound | 10 | Zincate treatment | | |
| Example 13 | Aluminum | 0.2 | Aluminum oxide | 10 | Anodizing treatment | | |
| Example 14 | Aluminum | 0.2 | Aluminum oxide | 10 | Anodizing treatment | | |
| Example 15 | Aluminum | 0.2 | Aluminum oxide | 10 | Anodizing treatment | | |
| Example 16 | Aluminum | 0.2 | Aluminum oxyhydroxide | 10 | Boehmite treatment | | |
| Example 17 | Aluminum | 0.2 | Chromium-containing | 10 | Chromate treatment | | |
| | | | compound | | | | |
| Example 18 | Aluminum | 0.2 | Zinc-containing compound | 10 | Zincate treatment | | |
| Example 19 | Aluminum | 0.2 | Aluminum oxide | 10 | Anodizing treatment | | |
| Comparative | Aluminum | 0.2 | Aluminum oxide | 2 | Anodizing treatment | | |
| example 1 | | | | | | | |
| Comparative | Aluminum | 0.2 | Aluminum oxide | 10 | Anodizing treatment | | |
| example 2 | | | | | | | |
| Comparative | Aluminum | 0.2 | — | — | No treatment | | |
| example 3 | | | | | | | |
| Comparative | Aluminum | 0.2 | — | — | No treatment | | |
| example 4 | | | | | | | |
| Comparative | Aluminum | 0.2 | Aluminum oxide | 10 | Anodizing treatment | | |
| example 5 | | | | | | | |
| Comparative | Zinc | 0.5 | — | — | No treatment | | |
| example 6 | | | | | | | |
| Comparative | Tin | 0.5 | — | — | No treatment | | |
| example 7 | | | | | | | |
| | Negative electrode lead | | | | | | Presence/ |
| | Treatment conditions | | | | | | absence |
| | Anodizing treatment | | Boehmite treatment | | Chromate treatment | | of water- |
| | Current | Application | Solution | Treatment | Chromium | Zincate treatment | repellent |
| | density | time | temperature | time | substitution step | Zinc substitution step | number at |
| | (mA/cm²) | (seconds) | (° C.) | (minutes) | Time (seconds) | Time (seconds) | joint |
| Example 1 | 10 | 300 | — | — | — | — | Absence |
| Example 2 | 10 | 300 | — | — | — | — | Absence |
| Example 3 | 10 | 300 | — | — | — | — | Absence |
| Example 4 | 10 | 900 | — | — | — | — | Absence |
| Example 5 | 10 | 900 | — | — | — | — | Absence |
| Example 6 | — | — | 90 | 50 | — | — | Absence |
| Example 7 | — | — | — | — | 300 | — | Absence |
| Example 8 | — | — | — | — | — | 600 (conducted twice) | Absence |
| Example 9 | 10 | 90 | — | — | — | — | Absence |
| Example 10 | 10 | 300 | — | — | — | — | Absence |
| Example 11 | — | — | — | — | — | 600 (conducted twice) | Absence |
| Example 12 | — | — | — | — | — | 600 (conducted twice) | Absence |
| Example 13 | 10 | 300 | — | — | — | — | Absence |
| Example 14 | 10 | 300 | — | — | — | — | Absence |
| Example 15 | 10 | 300 | — | — | — | — | Absence |
| Example 16 | — | — | 90 | 50 | — | — | Absence |
| Example 17 | — | — | — | — | 300 | — | Absence |
| Example 18 | — | — | — | — | — | 600 (conducted twice) | Absence |
| Example 19 | 10 | 300 | — | — | — | — | Presence |
| Comparative | 10 | 60 | — | — | — | — | Absence |
| example 1 | | | | | | | |
| Comparative | 10 | 300 | — | — | — | — | Absence |
| example 2 | | | | | | | |
| Comparative | — | — | — | — | — | — | Absence |
| example 3 | | | | | | | |
| Comparative | — | — | — | — | — | — | Absence |
| example 4 | | | | | | | |
| Comparative | 10 | 300 | — | — | — | — | Absence |
| example 5 | | | | | | | |
| Comparative | — | — | — | — | — | — | Absence |
| example 6 | | | | | | | |
| Comparative | — | — | — | — | — | — | Absence |
| example 7 | | | | | | | |

In each of the secondary batteries according to Examples 1 to 19, each of the electrode current collectors included in both the positive and negative electrodes and the lead members electrically connected to these electrode current collectors has a specific material and has a specific type of protective coating. In addition, the thickness of the lead coating is larger than the thickness of the current collector coating on at least one of the positive electrode side and the negative electrode side. Therefore, in Examples 1 to 19, excellent charge/discharge efficiency was obtained as compared with Comparative Examples 1 to 7.

Excellent charge/discharge efficiency was obtained in the case where the thicknesses of the lead coatings are larger than the thicknesses of the current collector coatings on both the positive electrode side and the negative electrode side (Examples 1 to 8), as compared with the case where the thickness of the lead coating is larger than the thickness of the current collector coating on only one of the positive electrode side and the negative electrode side (Examples 9 and 10).

Regarding Examples 1 to 8, for example, excellent charge/discharge efficiency was obtained in Examples 6 to 8 in which the composition of the current collector coatings and the lead coatings was changed, as in the case where the current collector coatings and the lead coatings are aluminum oxide (Example 2).

Even when copper or nickel was used as the negative electrode current collector and the negative electrode lead (Examples 11 and 12), excellent charge/discharge efficiency was obtained as in the case where aluminum was used (for example, Example 2).

Examples 13 to 15 are examples in which the composition of the positive electrode current collector coating and the composition of the positive electrode lead coating are different from each other. Further, Examples 16 to 18 are examples in which the composition of the negative electrode current collector coating and the composition of the negative electrode lead coating are different from each other. As described above, excellent charge/discharge efficiency can be achieved even when the composition of the current collector coating and the composition of the lead coating are different in each electrode.

In the secondary battery according to Example 19, the entire positive electrode joint and the entire negative electrode joint were both covered with the water-repellent member. Therefore, Example 19 showed excellent charge/discharge efficiency as compared with Example 1 in which the positive electrode joint and the negative electrode joint are not covered with a water-repellent member.

In the secondary battery according to Comparative Example 1, each of the electrode current collectors included in both the positive and negative electrodes and the lead members electrically connected to the electrode current collectors has a specific material and a specific type of protective coating. However, in the secondary battery, the thicknesses of the lead coatings were smaller than the thicknesses of the current collector coatings on both the positive electrode side and the negative electrode side, so that the charge/discharge efficiency according to Comparative Example 1 was low. It is considered that this is because the lead coatings were thinner than the current collector coatings, and the lead base material (base material) was easily exposed due to physical damage when the leads and the current collectors were joined, so that side reactions were likely to occur.

In the secondary battery according to Comparative Example 2, the negative electrode current collector was made of aluminum and had aluminum oxide as the negative electrode current collector coating, and the negative electrode lead was made of aluminum and had aluminum oxide as the negative electrode lead coating. Further, the thickness of the negative electrode lead coating was larger than the thickness of the negative electrode current collector coating. However, in the secondary battery according to Comparative Example 2, neither the positive electrode current collector nor the positive electrode lead was provided with a protective coating. Therefore, it is considered that Comparative Example 2 was inferior in charge/discharge efficiency because it was not possible to suppress the oxidative decomposition of water in the positive electrode.

In the secondary battery according to Comparative Example 3, the positive electrode current collector was made of aluminum and had aluminum oxide as the positive electrode current collector coating, and the positive electrode lead was made of aluminum and aluminum oxide was used as the positive electrode lead coating. Further, the thickness of the positive electrode lead coating was larger than the thickness of the positive electrode current collector coating. However, in the secondary battery according to Comparative Example 3, neither the negative electrode current collector nor the negative electrode lead was provided with a protective coating. Therefore, it is considered that Comparative Example 3 was inferior in charge/discharge efficiency because it was not possible to suppress the reductive decomposition of water in the negative electrode.

In Comparative Example 4 in which neither a current collector coating nor a lead coating was not provided on both the positive electrode side and the negative electrode side, the charge/discharge efficiency was low.

In Comparative Example 5 in which a titanium foil was used as the positive electrode current collector and the positive electrode lead, Comparative Example 6 in which a zinc foil was used as the negative electrode current collector and the negative electrode lead, and Comparative Example 7 in which a tin foil was used as the negative electrode current collector and the negative electrode lead, the charge/discharge efficiency was inferior to that of Examples.

According to at least one embodiment and one Example described above, a secondary battery is provided. The secondary battery includes a first electrode having a first current collector, a second electrode having a second current collector, and an aqueous electrolyte. The first electrode includes a first lead, and a first joint for electrically connecting the first current collector and the first lead. The second electrode includes a second lead, and a second joint for electrically connecting the second current collector and the second lead. The first electrode is one of a positive electrode and a negative electrode, and the second electrode is the other of the positive electrode and the negative electrode. At least a part of the surface of the first current collector has a first current collector coating. At least a part of the surface of the first lead has a first lead coating. Each of the first current collector and the first lead contains at least one selected from the group consisting of aluminum, aluminum alloys, copper, and nickel. Each of the first lead coating and the first current collector coating contains at least one selected from the group consisting of aluminum oxide, aluminum oxyhydroxide, chromium-containing compounds, and zinc-containing compounds. At least a part of the surface of the second current collector has a second current collector coating. At least a part of the surface of the second lead has a second lead coating. Each of the second current collector and the second lead contains at least one selected from the group consisting of aluminum, aluminum alloys, copper, and nickel. Each of the second lead coating and the second current collector coating contains at least one selected from the group consisting of aluminum oxide, aluminum oxyhydroxide, chromium-containing compounds, and zinc-containing compounds. The thickness of the first lead coating is larger than the thickness of the first current collector coating.

Therefore, since the electrolysis of water in the vicinity of the first joint can be suppressed, excellent charge/discharge efficiency can be maintained even after the charge/discharge cycle is repeated a plurality of times.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A secondary battery comprising:
a first electrode comprising a first current collector;
a second electrode comprising a second current collector; and
an aqueous electrolyte,
wherein
the first electrode comprises a first lead, and a first joint for electrically connecting the first current collector and the first lead,
the second electrode comprises a second lead, and a second joint for electrically connecting the second current collector and the second lead,
the first electrode is one of a positive electrode and a negative electrode,
the second electrode is the other of the positive electrode and the negative electrode,
at least a part of a surface of the first current collector has a first current collector coating,
at least a part of a surface of the first lead has a first lead coating,
each of the first current collector and the first lead comprises at least one selected from the group consisting of aluminum, aluminum alloys, copper, and nickel,
each of the first lead coating and the first current collector coating comprises at least one selected from the group consisting of aluminum oxide, aluminum oxyhydroxide, chromium-containing compounds, and zinc-containing compounds,
at least a part of a surface of the second current collector has a second current collector coating,
at least a part of a surface of the second lead has a second lead coating,
each of the second current collector and the second lead comprises at least one selected from the group consisting of aluminum, aluminum alloys, copper, and nickel,
each of the second lead coating and the second current collector coating comprises at least one selected from the group consisting of aluminum oxide, aluminum oxyhydroxide, chromium-containing compounds, and zinc-containing compounds, and
the thickness of the first lead coating is larger than the thickness of the first current collector coating.

2. The secondary battery according to claim 1, wherein the thickness of the second lead coating is larger than the thickness of the second current collector coating.

3. The secondary battery according to claim 1, wherein the thickness of the first current collector coating is in the range of 1 μm or more and 10 μm or less.

4. The secondary battery according to claim 1, wherein the thickness of the first lead coating is in the range of 2 μm or more and 100 μm or less.

5. The secondary battery according to claim 1, wherein
at least a part of the first joint is covered with a water-repellent member, and
the water-repellent member comprises at least one water-repellent material selected from the group consisting of polytetrafluoroethylene, tetrafluoroethylene-fluorinated propylene copolymer, polypropylene, polyethylene, polyimide, polystyrene, silicone, and epoxy resin.

6. The secondary battery according to claim 1, wherein
the negative electrode comprises a negative electrode active material-containing layer comprising a negative electrode active material, and
the negative electrode active material comprises at least one titanium-containing oxide selected from the group consisting of titanium oxide, lithium titanium composite oxide, niobium titanium composite oxide, and sodium niobium titanium composite oxide.

7. A battery pack comprising the secondary battery according to claim 1.

8. The battery pack according to claim 7, further comprising:
an external power distribution terminal; and
a protective circuit.

9. The battery pack according to claim 7, comprising a plurality of the secondary battery, wherein
the secondary batteries are electrically connected in series or parallel to one another, or in series and parallel to one another.

10. A vehicle comprising the battery pack according to claim 7.

11. A stationary power supply comprising the battery pack according to claim 7.
